(19) United States
(12) Patent Application Publication
(10) Pub. No.: US 2026/0046666 A1
(43) Pub. Date: Feb. 12, 2026

(54) CHANNEL STATE INFORMATION REPORT USING INTERFERENCE MEASUREMENT RESOURCES

(71) Applicant: QUALCOMM Incorporated, San Diego, CA (US)

(72) Inventors: Qiaoyu LI, Beijing (CN); Wooseok NAM, San Diego, CA (US); Junyi LI, Greentown, PA (US); Sony AKKARAKARAN, Poway, CA (US); Tao LUO, San Diego, CA (US); Mahmoud TAHERZADEH BOROUJENI, San Diego, CA (US); Yan ZHOU, San Diego, CA (US); Peter GAAL, San Diego, CA (US)

(21) Appl. No.: 19/103,075

(22) PCT Filed: Sep. 22, 2022
(86) PCT No.: PCT/CN2022/120471

§ 371 Date: Feb. 11, 2025

(51) Int. Cl. H04W 24/10; H04B 7/06

(52) U.S. Cl. CPC H04W 24/10; H04B 7/06952

(57) ABSTRACT

Various aspects of the present disclosure generally relate to wireless communication. In some aspects, a user equipment (UE) may generate a channel state information (CSI) report based at least in part on one or more virtual interference measurement resources (IMRs), each virtual IMR representing a logical resource that is used for beam management and is not transmitted. The UE may transmit the CSI report. Numerous other aspects are described.

### FIELD OF THE DISCLOSURE

Aspects of the present disclosure generally relate to wireless communication and to techniques and apparatuses for channel state information reporting for interference management resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE) or an apparatus of a UE. The method may include generating a channel state information (CSI) report based at least in part on one or more virtual interference measurement resources (IMRs), each virtual IMR representing a logical resource that is used for beam management and is not transmitted. The method may include transmitting the CSI report.

Some aspects described herein relate to a method of wireless communication performed by a UE or an apparatus of a UE. The method may include generating a CSI report based at least in part on one or more IMRs that are transmitted and one or more virtual channel measurement resources (CMRs), each virtual CMR representing a logical resource that is used for beam management and is not transmitted. The method may include transmitting the CSI report.

Some aspects described herein relate to a method of wireless communication performed by a network entity or an apparatus of a network entity. The method may include transmitting a configuration for generating a CSI report based at least in part on one or more virtual IMRs, each virtual IMR representing a logical resource that is used for beam management and is not transmitted, and one or more of: one or more CMRs, or one or more virtual CMRs, each virtual CMR representing a logical resource that is used for beam management and is not transmitted. The method may include receiving the CSI report.

Some aspects described herein relate to a method of wireless communication performed by a network entity or an apparatus of a network entity. The method may include transmitting a configuration for generating a CSI report based at least in part on one or more IMRs that are transmitted and one or more virtual CMRs, each virtual CMR representing a logical resource that is used for beam management and is not transmitted. The method may include receiving the CSI report.

Some aspects described herein relate to an apparatus of a UE for wireless communication. The apparatus may include a memory and one or more processors coupled to the memory. The one or more processors may be configured to generate a CSI report based at least in part on one or more virtual IMRs, each virtual IMR representing a logical resource that is used for beam management and is not transmitted. The one or more processors may be configured to transmit the CSI report.

Some aspects described herein relate to an apparatus of a UE for wireless communication. The apparatus may include a memory and one or more processors coupled to the memory. The one or more processors may be configured to generate a CSI report based at least in part on one or more IMRs that are transmitted and one or more virtual CMRs, each virtual CMR representing a logical resource that is used for beam management and is not transmitted. The one or more processors may be configured to transmit the CSI report.

Some aspects described herein relate to an apparatus of a network entity for wireless communication. The apparatus may include a memory and one or more processors coupled to the memory. The one or more processors may be configured to transmit a configuration for generating a CSI report based at least in part on one or more virtual IMRs, each virtual IMR representing a logical resource that is used for beam management and is not transmitted, and one or more of: one or more CMRs, or one or more virtual CMRs, each virtual CMR representing a logical resource that is used for beam management and is not transmitted. The one or more processors may be configured to receive the CSI report.

Some aspects described herein relate to an apparatus of a network entity for wireless communication. The apparatus may include a memory and one or more processors coupled to the memory. The one or more processors may be configured to transmit a configuration for generating a CSI report based at least in part on one or more IMRs that are transmitted and one or more virtual CMRs, each virtual CMR representing a logical resource that is used for beam management and is not transmitted. The one or more processors may be configured to receive the CSI report.

Some aspects described herein relate to a non-transitory computer-readable medium that stores a set of instructions for wireless communication by a UE. The set of instructions, when executed by one or more processors of the UE, may cause the UE to generate a CSI report based at least in part on one or more virtual IMRs, each virtual IMR representing a logical resource that is used for beam management and is not transmitted. The set of instructions, when executed by one or more processors of the UE, may cause the UE to transmit the CSI report.

Some aspects described herein relate to a non-transitory computer-readable medium that stores a set of instructions for wireless communication by a UE. The set of instructions, when executed by one or more processors of the UE, may cause the UE to generate a CSI report based at least in part on one or more IMRs that are transmitted and one or more virtual CMRs, each virtual CMR representing a logical resource that is used for beam management and is not transmitted. The set of instructions, when executed by one or more processors of the UE, may cause the UE to transmit the CSI report.

Some aspects described herein relate to a non-transitory computer-readable medium that stores a set of instructions for wireless communication by a network entity. The set of instructions, when executed by one or more processors of the network entity, may cause the network entity to transmit a configuration for generating a CSI report based at least in part on one or more virtual IMRs, each virtual MMR representing a logical resource that is used for beam management and is not transmitted, and one or more of: one or more CMRs, or one or more virtual CMRs, each virtual CMR representing a logical resource that is used for beam management and is not transmitted. The set of instructions, when executed by one or more processors of the network entity, may cause the network entity to receive the CSI report.

Some aspects described herein relate to a non-transitory computer-readable medium that stores a set of instructions for wireless communication by a network entity. The set of instructions, when executed by one or more processors of the network entity, may cause the network entity to transmit a configuration for generating a CSI report based at least in part on one or more IMRs that are transmitted and one or more virtual CMRs, each virtual CMR representing a logical resource that is used for beam management and is not transmitted. The set of instructions, when executed by one or more processors of the network entity, may cause the network entity to receive the CSI report.

Some aspects described herein relate to an apparatus for wireless communication. The apparatus may include means for generating a CSI report based at least in part on one or more virtual IMRs, each virtual IMR representing a logical resource that is used for beam management and is not transmitted. The apparatus may include means for transmitting the CSI report.

Some aspects described herein relate to an apparatus for wireless communication. The apparatus may include means for generating a CSI report based at least in part on one or more IMRs that are transmitted and one or more virtual CMRs, each virtual CMR representing a logical resource that is used for beam management and is not transmitted. The apparatus may include means for transmitting the CSI report.

Some aspects described herein relate to an apparatus for wireless communication. The apparatus may include means for transmitting a configuration for generating a CSI report based at least in part on one or more virtual IMRs, each virtual IMR representing a logical resource that is used for beam management and is not transmitted, and one or more of, one or more CMRs, or one or more virtual CMRs, each virtual CMR representing a logical resource that is used for beam management and is not transmitted. The apparatus may include means for receiving the CSI report.

Some aspects described herein relate to an apparatus for wireless communication. The apparatus may include means for transmitting a configuration for generating a CSI report based at least in part on one or more IMRs that are transmitted and one or more virtual CMRs, each virtual CMR representing a logical resource that is used for beam management and is not transmitted. The apparatus may include means for receiving the CSI report.

Aspects generally include a method, apparatus, system, computer program product, non-transitory computer-readable medium, UE, mobile station, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example architecture of a functional framework for radio access network intelligence enabled by data collection, in accordance with the present disclosure.

FIG. 6 is a diagram illustrating an example of artificial intelligence or machine learning based beam management, in accordance with the present disclosure.

FIGS. 7A and 7B are diagrams illustrating an example associated with connections between resources for predictive beam management, in accordance with the present disclosure.

FIG. 8 is a diagram illustrating an example of connections between channel measurement resources (CMRs) and interference measurement resources (IMRs), in accordance with the present disclosure.

FIG. 9 is a diagram illustrating examples of CMR and IMR combinations, in accordance with the present disclosure.

FIG. 10 is a diagram illustrating an example associated with generating a CSI report based on virtual IMRs, in accordance with the present disclosure.

FIG. 11 is a diagram illustrating an example associated with generating a CSI report based on actual IMRs, in accordance with the present disclosure.

FIG. 12 is a diagram illustrating an example process performed, for example, by a UE, in accordance with the present disclosure.

FIG. 13 is a diagram illustrating an example process performed, for example, by a UE, in accordance with the present disclosure.

FIG. 14 is a diagram illustrating an example process performed, for example, by a network entity, in accordance with the present disclosure.

FIG. 15 is a diagram illustrating an example process performed, for example, by a network entity, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

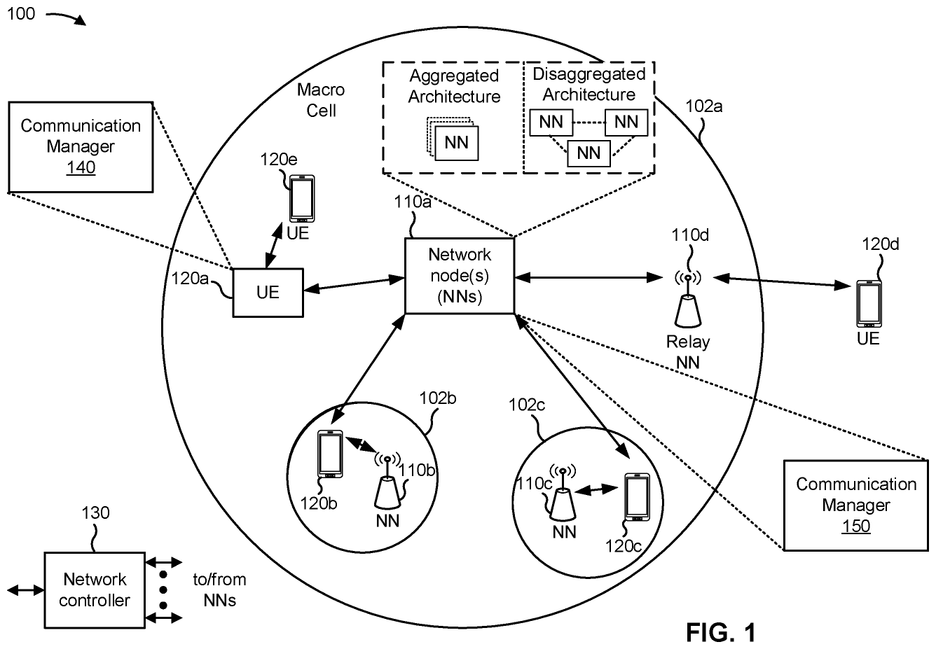

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmit receive point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (LAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station,” “network node,” “network entity” may refer to one device configured to perform one or more functions, such as those described herein in connection with the network node 110. In some aspects, the terms “base station,” “network node,” “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station,” “network node,” “network entity” may refer to any one or more of those different devices. In some aspects, the terms “base station,” “network node,” “network entity” may refer to one or more virtual base stations or one or more virtual base station functions. For example, in some aspects, two or more base station functions may be instantiated on a single device. In some aspects, the terms “base station,” “network node,” “network entity” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may generate a channel state information (CSI) report based at least in part on one or more virtual interference measurement resources (IMRs), each virtual IMR representing a logical resource that is used for beam management and is not transmitted. The communication manager 140 may transmit the CSI report.

In some aspects, the communication manager 140 may generate a CSI report based at least in part on one or more IMRs that are transmitted and one or more virtual channel measurement resources (CMRs), each virtual CMR representing a logical resource that is used for beam management and is not transmitted. The communication manager 140 may transmit the CSI report. Additionally, or alternatively, the communication manager 140 may perform one or more other operations described herein.

In some aspects, a network entity (e.g., network node 110) may include a communication manager 150. As described in more detail elsewhere herein, the communication manager 150 may transmit a configuration for generating a CSI report based at least in part on one or more virtual IMRs, each virtual IMR representing a logical resource that is used for beam management and is not transmitted, and one or more of: one or more CMRs, or one or more virtual CMRs, each virtual CMR representing a logical resource that is used for beam management and is not transmitted. The communication manager 150 may receive the CSI report.

In some aspects, the communication manager 150 may transmit a configuration for generating a CSI report based at least in part on one or more IMRs that are transmitted and one or more virtual CMRs, each virtual CMR representing a logical resource that is used for beam management and is not transmitted. The communication manager 150 may receive the CSI report. Additionally, or alternatively, the communication manager 150 may perform one or more other operations described herein.

As indicated above, FIG. 1 is provided as an example. Other examples may differ from what is described with regard to FIG. 1.

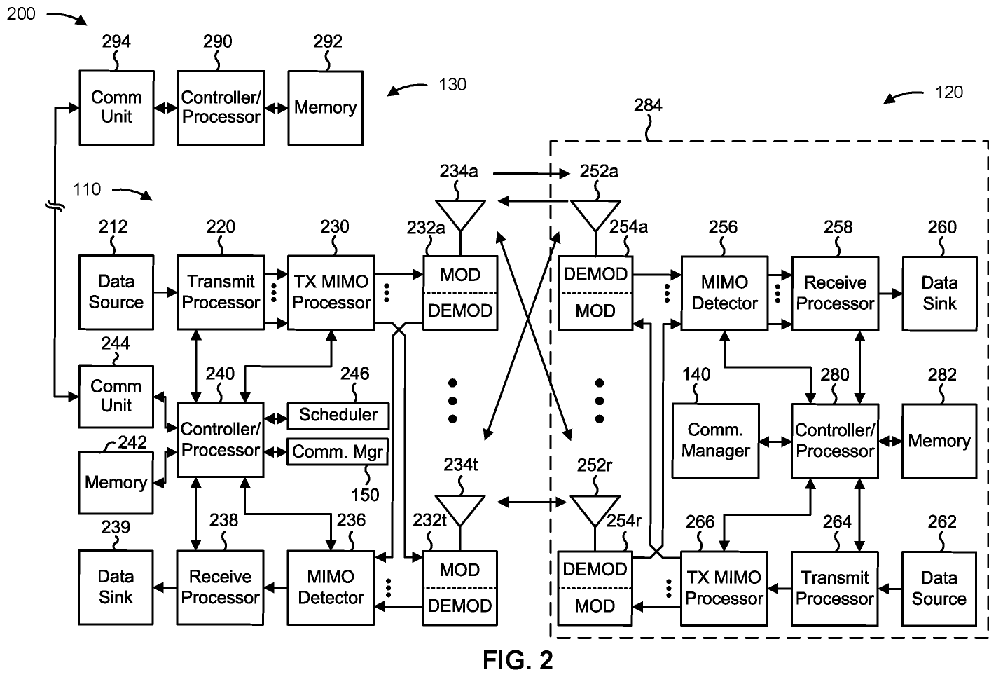

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

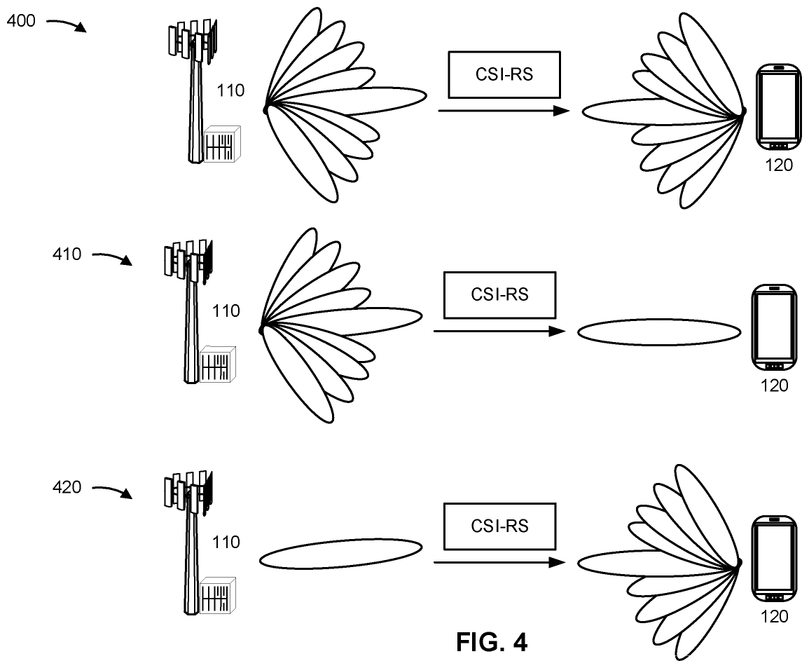

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-17).

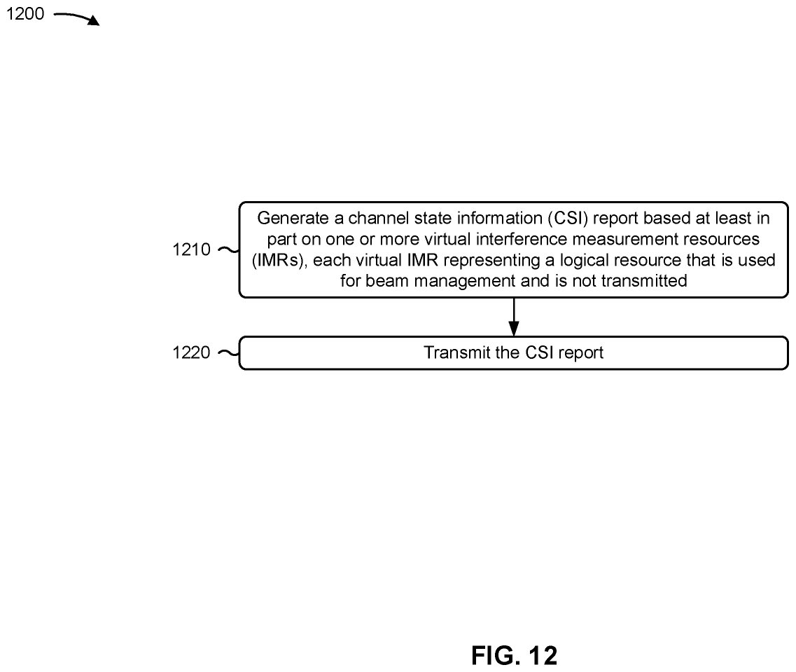

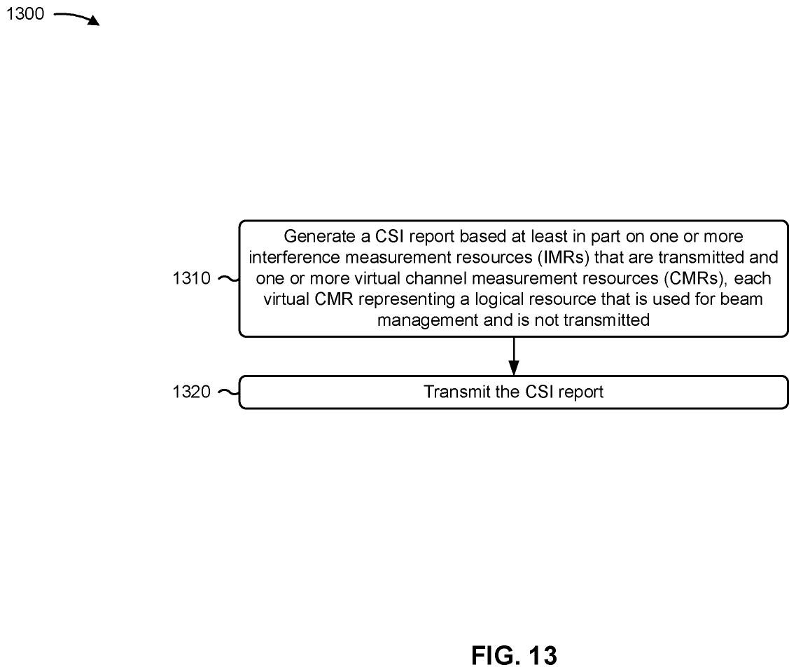

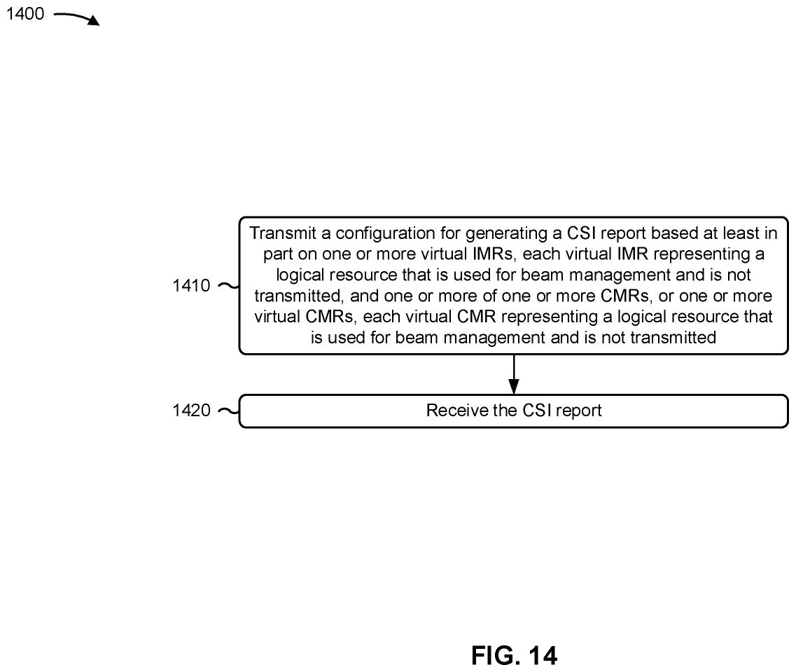

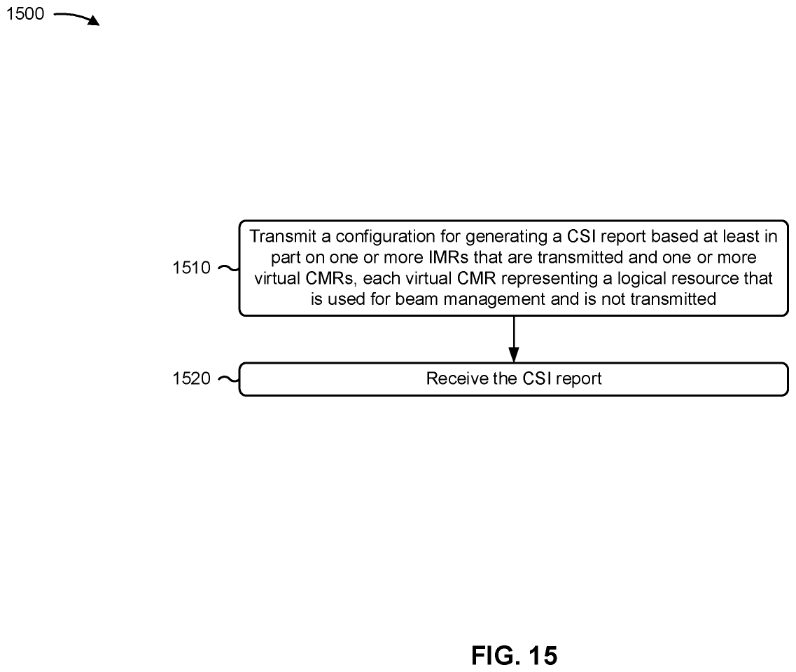

The controller/processor of a network entity (e.g., controller/processor 240 of the network node 110), the controller/processor 280 of the UE 120, and/or any other component(s) of FIG. 2 may perform one or more techniques associated with CSI reporting for virtual IMRs and virtual CMRs, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, the UE 120 includes means for generating a CSI report based at least in part on one or more virtual IMRs, each virtual IMR representing a logical resource that is used for beam management and is not transmitted; and/or means for transmitting the CSI report. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for generating a CSI report based at least in part on one or more IMRs that are transmitted and one or more virtual CMRs, each virtual CMR representing a logical resource that is used for beam management and is not transmitted; and/or means for transmitting the CSI report.

In some aspects, a network entity (e.g., network node 110) includes means for transmitting a configuration for generating a CSI report based at least in part on one or more virtual IMRs, each virtual IMR representing a logical resource that is used for beam management and is not transmitted, and one or more of: one or more CMRs, or one or more virtual CMRs, each virtual CMR representing a logical resource that is used for beam management and is not transmitted; and/or means for receiving the CSI report. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network entity includes means for transmitting a configuration for generating a CSI report based at least in part on one or more IMRs that are transmitted and one or more virtual CMRs, each virtual CMR representing a logical resource that is used for beam management and is not transmitted; and/or means for receiving the CSI report.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

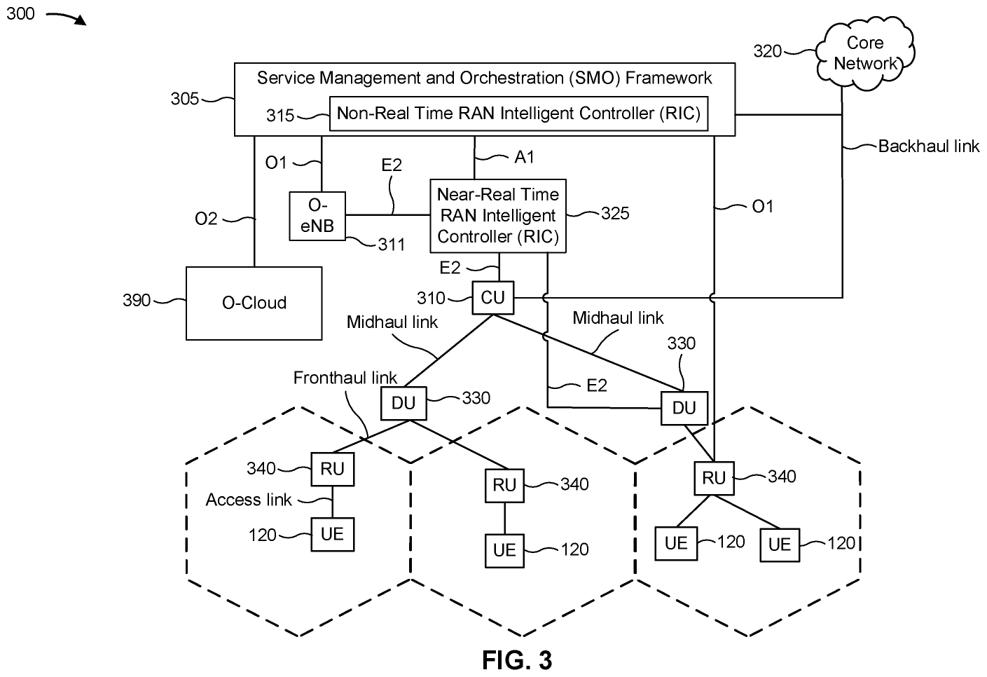

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-e NB, with the Near-RT RIC 325. In some examples, the near-RT RIC 325 may be a logical function that enables near-real-time control and optimization of O-RAN elements and resources via fine-grained data collection and actions over an E2 interface. The Near-RT RIC 325 may be collocated with the RAN or network entity to provide the real-time processing, such as online ML training or near real time ML inference. The non-RT RIC 315 may be a logical function that enables non-real-time control and optimization of RAN elements and resources, AI/ML workflow including model training and updates, and policy-based guidance of applications/features in near-RT RIC 325, as well as ML inference with less latency specification. The non-RT RIC 315 may be located further from the RAN or network node, such as on a cloud-based server or on an edge server.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 410, and 420 of beam management procedures, in accordance with the present disclosure. As shown in FIG. 4, examples 400, 410, and 420 include a UE 120 in communication with a network entity (e.g., network node 110) in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHz, FR4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal toward a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spreads (e.g., few nanoseconds) and may be translated into coherence frequency bandwidths of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on an LOS path at a higher frequency band and the LOS path is blocked by an obstacle, such as a pedestrian, building, and/or vehicle, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (e.g., such as the beam management procedures described in connection with FIG. 4) may be performed by the UE 120 and/or the network node 110. However, because higher frequency bands may be more susceptible to environmental changes compared to lower frequency bands, the beam management procedures may need to be performed more frequently and/or using additional beams. This may introduce significant overhead and consume network resources, processing resources, and/or power resources of a UE (and/or a network node) associated with performing the beam management procedures.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

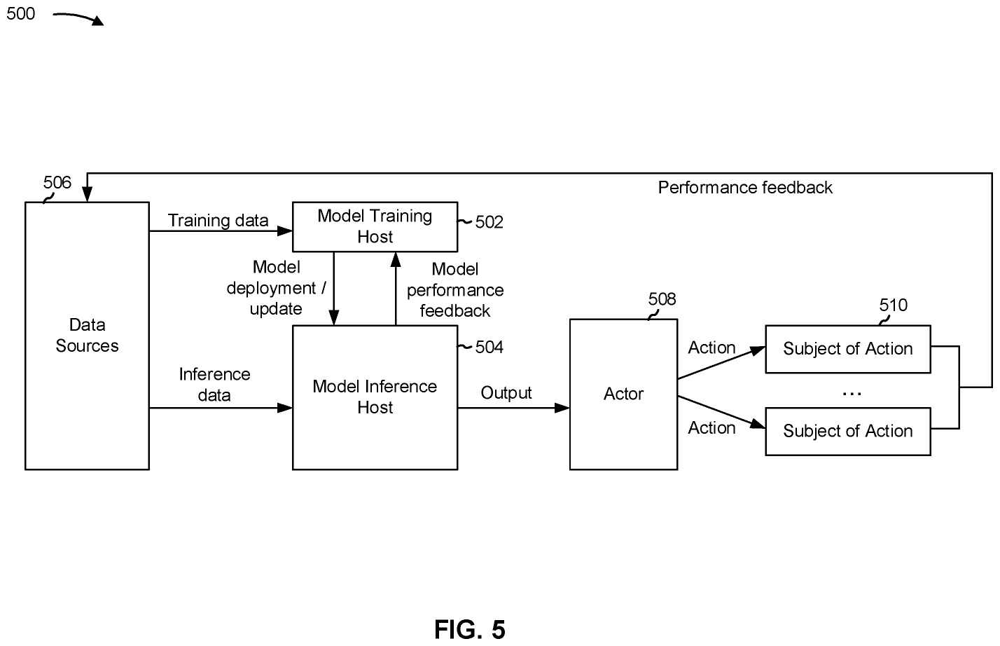

FIG. 5 is a diagram illustrating an example architecture 500 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, a network entity, a base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE, a DU or an RU; whereas if the output from the model inference host 504 is associated with Tx/Rx scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change/modify a Tx/Rx beam based on the output. If the actor 508 determines to act based on the output, the actor 508 may indicate the action to at least one subject of action 510. For example, if the actor 508 determines to change/modify a Tx/Rx beam for a communication between the actor 508 and the subject of action 510 (e.g., a UE 120), then the actor 508 may transmit a beam (re-)configuration or a beam switching indication to the subject of action 510. The actor 508 may modify its Tx/Rx beam based on the beam (re-) configuration, such as switching to a new Tx/Rx beam or applying different parameters for a Tx/Rx beam, among other examples. As another example, the actor 508 may be a UE and the output from the model inference host 504 may be associated with beam management. For example, the output may be one or more predicted measurement values for one or more beams. The actor 508 (e.g., a UE) may determine that a measurement report (e.g., a Layer 1 (L1) RSRP report) is to be transmitted to a network node 110.

The data sources 506 may also be configured for collecting data that is used as training data for training an ML model or as inference data for feeding an ML model inference operation. For example, the data sources 506 may collect data from one or more core network and/or RAN entities, which may include the subject of action 510, and provide the collected data to the model training host 502 for ML model training. For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

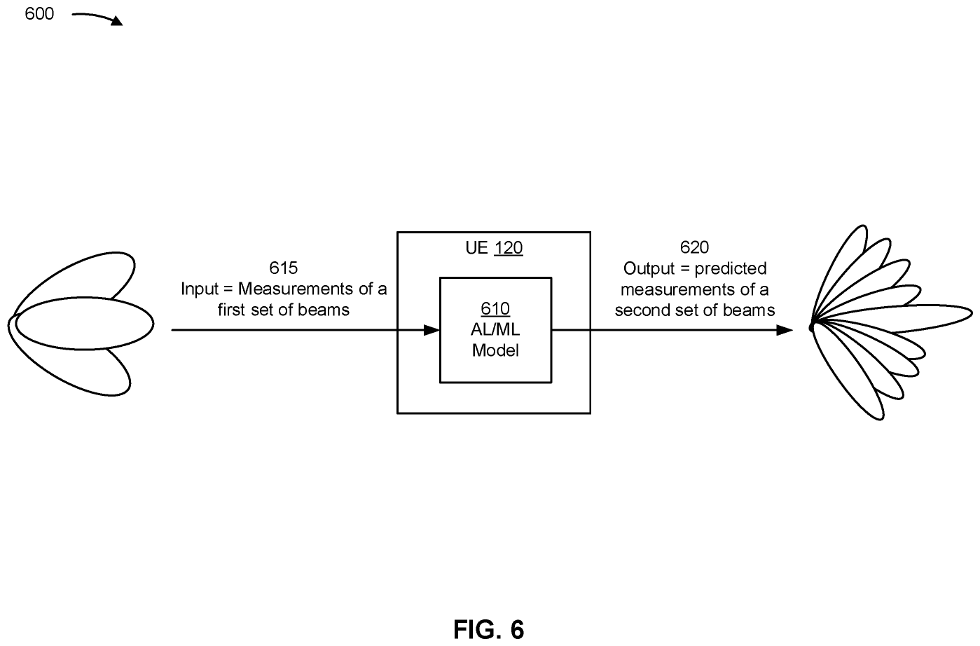

FIG. 6 is a diagram illustrating an example 600 of an AI/ML based beam management, in accordance with the present disclosure. As shown in FIG. 6, an AI/ML model 610 may be deployed at or on a UE 120. For example, a model inference host (such as a model inference host 504) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurements associated with a first set of beams. For example, a network node 110 may transmit one or more signals values respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 610 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 620, the AI/ML model 610 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 610. This may enable the AI/ML model 610 to output codebook based and/or non-codebook based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure as described above in connection with FIG. 4), link quality or interference adaptation procedure, beam failure and/or beam blockage predictions, and/or radio link failure predictions, among other examples. This may lead to better management accuracy without excessive beam sweeping.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

As described above, to perform the predictions described herein, the UE 120 and/or the AI/ML model 610 may expect information associated with the first set of beams and/or the second set of beams in order to accurately perform the predictions. For example, the UE 120 and/or the AI/ML model 610 may use information such as a beam direction (e.g., spatial direction), beam width, beam shape, and/or other characteristics of the respective beams from the first set of beams and/or the second set of beams to accurately perform the predictions described above. However, this information may be associated with beamforming techniques performed at a network entity (e.g., network node 110). Therefore, the network node 110 may transmit, and the UE 120 may receive the information (e.g., a beam direction (e.g., spatial direction), beam width, beam shape, and/or other characteristics of the respective beams from the first set of beams and/or the second set of beams). However, this may consume significant signaling overhead, especially in cases where the network node 110 may dynamically change beamforming techniques or shapes (e.g., thereby requiring another transmission of the information described above). Further, explicit indications of the beamforming techniques performed at a network node 110 may expect detailed disclosures of proprietary or confidential information. Therefore, in some cases, a network node 110 may not provide explicit indications of some, or all, of the information needed by the UE 120 to accurately perform the predictions described above. As a result, AI/ML predictions performed by the UE 120 may be degraded because the UE 120 may not have access to information of beam characteristics or shapes of beams associated with the AIML predictions.

In some aspects, there may be connections between resources for predictive beam management. For example, the UE 120 may receive an indication of a first set of resources and a second set of resources and an indication of one or more connections between the first set of resources and the second set of resources. The one or more connections may include a connection associated with a resource, included in the first set of resources or the second set of resources, that is defined with respect to one or more resources included in a different set of resources from the first set of resources or the second set of resources. In other words, the connections may be implicit connections defining beam characteristics associated with a given resource with respect to beams associated with other resources(s) that are included in a different set. In some examples, the connection described herein may be referred to as an implicit connection, an association, a relation, a relationship, a correspondence, a mapping, and/or a link, among other examples. The connection may indicate a relationship between a first spatial direction or a first beam associated with the resource and second spatial directions or second beams of the one or more resources included in the different set of resources. The first set of resources may be channel measurement resources for a CSI report and the second set of resources may be resources that are not to be actually measured by the UE 120 (e.g., nominal resources). For example, the first set of resources may be associated with Set B beams and the second set of resources may be associated with Set A beams. In some aspects, the connections may be graph-based connections or may be linear combinations.

The UE 120 may transmit a CSI report indicating measurement values associated with the first set of resources and the second set of resources. A first one or more measurement values, from the measurement values, associated with the first set of resources may be measured by the UE 120. A second one or more measurement values, from the measurement values, associated with the second set of resources may be predicted by the UE 120 based at least in part on the first one or more measurement values and the one or more connections. In other words, the UE 120 may use the connections between the first set of resources and the second set of resources to obtain beam characteristics or beam shapes associated with the first set of resources and the second set of resources. The UE 120 may use the beam characteristics or beam shapes associated with the first set of resources and the second set of resources to perform one or more AI/ML predictions associated with the first set of resources and the second set of resources.

In some aspects, one or more resources included in the second set of resources may be used for a transmission configuration indicator (TCI) state indication. Additionally, or alternatively, one or more resources included in the second set of resources may be used by the UE 120 as a source reference for a quasi-co-location (QCL) source (e.g., even though the UE 120 has not actually received and/or measured signal(s) via the second set of resources).

As a result, the UE 120 may be enabled to perform improved predictive beam management by obtaining beam characteristics (e.g., beam shape and/or beam width) associated with the first set of resources and the second set of resources. Additionally, by using implicit connections between two sets of resources, the UE 120 and/or a network node 110 may conserve a signaling overhead, network resources, processing resources, and/or power associated with indicating the beam characteristics (e.g., beam shape and/or beam width) associated with the first set of resources and the second set of resources. For example, by using implicit connections between the two sets of resources, detailed beamforming information or implementations performed at a network node 110 do not need to be disclosed or indicated to the UE 120.

As indicated above, FIG. 6 is provided as an example. Other examples may differ from what is described with regard to FIG. 6.

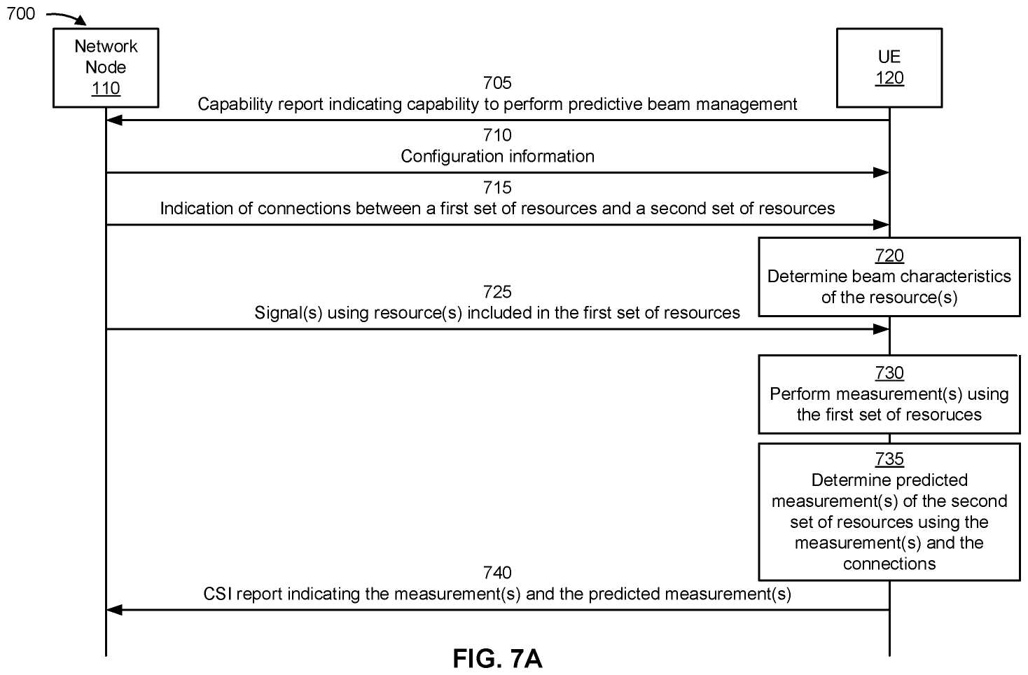

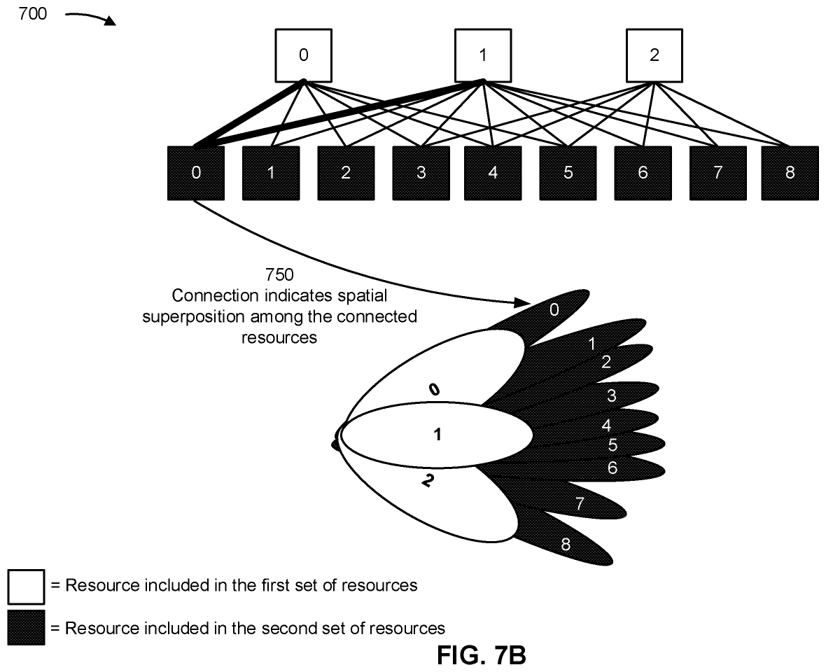

FIGS. 7A and 7B are diagrams illustrating an example 700 associated with connections between resources for predictive beam management, in accordance with the present disclosure. As shown in FIG. 7A, a network entity (e.g., network node 110, a base station, a CU, a DU, and/or an RU) may communicate with a UE 120. In some aspects, the network node 110 and the UE 120 may be part of a wireless network (e.g., the wireless network 100). The UE 120 and the network node 110 may have established a wireless connection prior to operations shown in FIG. 7A.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 7A, and by reference number 705, the UE 120 may transmit, and the network node 110 may receive, a capability report. The capability report may indicate that the UE 120 supports performing predictive beam management, as described herein. For example, the capability report may indicate that the UE 120 supports performing one or more operations as described in connection with FIGS. 5 and 6. In some aspects, the capability report may indicate that the UE 120 supports identifying beam information for performing predictive beam management using connections between two sets of resources, as described in more detail elsewhere herein. In some aspects, the UE 120 may be configured to perform one or more operations described herein based at least in part on the capability report indicating that the UE 120 supports performing predictive beam management.

As shown by reference number 710, the network node 110 may transmit, and the UE 120 may receive, configuration information. In some aspects, the UE 120 may receive the configuration information via one or more of system information signaling, RRC signaling, one or more MAC CEs, and/or DCI, among other examples. In some aspects, the configuration information may include an indication of one or more configuration parameters (e.g., already stored by the UE 120 and/or previously indicated by the network node 110 or other network device) for selection by the UE 120, and/or explicit configuration information for the UE 120 to use to configure itself, among other examples.

In some aspects, the configuration information may indicate that the UE 120 is to perform predictive beam management. For example, the configuration information may indicate that the UE 120 is to use an AI/ML model and/or a model inference host deployed at, or associated with, the UE 120 to predict measurement values (e.g., L1 RSRP values) associated with one or more beams. For example, the configuration information may indicate that the UE 120 is to predict measurement values associated with transmit beam(s) of the network node 110 (e.g., of an RU) using measurement value(s) (e.g., performed by the UE 120) of other transmit beam(s) of the network node 110.

In some aspects, the configuration information may indicate a first set of resources and a second set of resources. In some aspects, the first set of resources may include downlink reference signal resources, such as SSB resources or CSI-RS resources, among other examples. In some aspects, the first set of resources may be CMRs for CSI reporting (e.g., may be indicated via a resourcesForChannelMeasurement information element). In some aspects, the second set of resources may include nominal resources. As used herein, “nominal resource” may refer to a resource (e.g., a time-frequency resource or a radio resource) that is indicated or configured for the UE 120, but is not used for transmission (or is infrequently used for transmission) by the network node 110. For example, the second set of resources may include one or more downlink reference signal resources (e.g., SSB resources or CSI-RS resources) that are infrequently used, or not used, for transmissions by the network node 110. In some examples, the nominal resources may be virtual resources or logical resources (e.g., resources that are used for beam management (e.g., beam prediction) but not used for transmission or are not transmitted by the network node 110). Virtual resources may include virtual CMRs that are used for beam management but are not transmitted.

A UE may use virtual CMRs, which are not actually transmitted, as prediction targets for beam predictions. The network may indicate CMRs that are to be virtual resources. The UE may predict a virtual resource measurement and predict a proper receive beam for the virtual resource. The purpose of virtual resources is to improve beam prediction, and the purpose of beam prediction is to reduce overhead.

Virtual QCL-Type D resources may include virtual CMR Set-A beams, which are not actually transmitted but have beam shape/pointing-direction connections with actually transmitted CMR Set-B beams. For example, using SSB-based wide beams, a UE can predict narrow beam L1-RSRP measurements that are expected to be measured by CSI-RSs but are not transmitted to reduce UE power consumption for measurements and/or downlink RS overhead.

In some aspects, a given resource (e.g., from the first set of resources and/or the second set of resources) may be associated with a beam. For example, the network node 110 may associated a given resource with a given beam. In the case where the resource is used for transmission by the network node 110, the network node 110 may transmit using the resource and the beam. In some aspects, the first set of resources may be associated with Set B beams of the network node 110 and the second set of resources may be associated with Set A beams of the network node 110. In some aspects, the first set of resources may be a subset of the second set of resources. In some other aspects, the first set of resources may include different resources (e.g., may be mutually exclusive sets).

In some aspects, the configuration information may include a CSI configuration. For example, the configuration information may include a CSI report setting and/or a CSI resource setting, among other examples. As another example, the configuration information may include a CSI-ReportConfig configuration and/or a CSI-ResourceConfig configuration, among other examples. In other words, the configuration information may configure the UE 120 to transmit a CSI report including information (e.g., measurements) associated with the first set of resources and the second set of resources. As described above, the first set of resources may be CMRs for the CSI report.

In some aspects, the configuration information may indicate a report quantity configuration for the CSI report. For example, the UE 120 may be configured with a CSI-ReportConfig with the higher layer parameter reportQuantity set to either ‘none’, ‘cri-RI-PMI-CQI’, ‘cri-RI-il’, ‘cri-RI-il-COl’, ‘cri-RI-COl’, ‘cri-RSRP’, ‘ssb-Index-RSRP’ or ‘cri-RI-L1-PMI-COT, among other examples (for example, as defined, or otherwise fixed, by the 3GPP). The report quantity may indicate or configure what is to be included in the CSI report and/or what the UE 120 is to expect to be configured with for the CSI report, among other examples. In other words, the report quantity may indicate what kind of quantity (e.g., SSB RSRP, CQI, precoding matrix indicator (PMI), and/or rank indicator (RI)) should be measured and reported by the UE 120. For example, a wireless communication standard, such as the 3GPP, may define expectations and/or configurations for the CSI report for different values of the report quantity. In some aspects, a report quantity associated with the CSI report to be transmitted by the UE 120 may be based at least in part on the second set of resources (e.g., the nominal resources). For example, the second set of resources may be used to define the report quantity of the CSI configuration. In some aspects, the second set of resources may be used as references of report quantities in CSI reporting (e.g., the first set of resources may be used as CMRs for a CSI report, while the report quantities for the CSI report may be defined based at least in part on the second set of resources). For example, the UE 120 may receive a configuration (e.g., a CSI report setting, a CSI resource setting, a (′SI-ReportConfig, and/or a (′SI-ResourceConfig) for the CSI report. The configuration may indicate that the first set of resources are channel measurement resources associated with the CSI report and that the second set of resources are references associated with a report quantity associated with the CSI report.

The UE 120 may configure itself based at least in part on the configuration information. In some aspects, the UE 120 may be configured to perform one or more operations described herein based at least in part on the configuration information.

As shown by reference number 715, the network node 110 may transmit, and the UE 120 may receive, an indication of one or more connections between the first set of resources and the second set of resources. For example, the one or more connections may be implicit connections. In some aspects, the indication of one or more connections may be included in the configuration information (e.g., the configuration information and the indication of the one or more connections may be included in the same communication or configuration). In some other aspects, the indication of one or more connections may be transmitted to the UF 120 separate from the configuration information.

For example, a connection associated with a resource, included in the first set of resources or the second set of resources, may be defined with respect to one or more resources included in a different set of resources from the first set of resources or the second set of resources. In some aspects, the connection may indicate a relationship between a first spatial direction or a first beam associated with the resource and second spatial directions or second beams of the one or more resources included in the different set of resources. In other words, the connections may implicitly indicate beams and/or spatial directions associated with a given resource by connecting the given resource to one or more other resources included in a different set of resources.

FIG. 7B shows a spatial superposition relationship between a first spatial direction or a first beam associated with a resource and second spatial directions or second beams associated with the one or more resources included in the different set of resources. For example, a connection may indicate that a first beam width of the first beam associated with the resource may be overlapping with second beam widths of the second beams. In other words, if the graph indicates that a first resource (e.g., included in the second set of resources) is connected with a second resource (e.g., included in the first set of resources), then the UE 120 may assume the beam width associated with the first resource is within the beam width associated with the second resource.

In some aspects, a beam width may include an angular spread that is associated with an attenuation difference from a peak beamforming gain, of a beam associated with the beam width, that satisfies a threshold (e.g., X decibels (dB) of attenuation). In other words, beam width may be defined as angular spread that is within X dB attenuation with respect to the peak beamforming gain of the beam. In some aspects, a value of the threshold (e.g., X) may be defined, or otherwise fixed, by a wireless communication standard, such as the 3GPP. Additionally, or alternatively, a value of the threshold (e.g., X) may be included in the indication of the one or more connections between the first set of resources and the second set of resources. In some aspects, the threshold may include a first threshold (e.g., X1) associated with the first set of resources and a second threshold (e.g., X2) associated with the second set of resources.

As an example and as shown in FIG. 7B, resource 0 included in the second set of resources is connected to the resource 0 and the resource 1 included in the first set of resources. As shown by reference number 750, the connections may indicate spatial superpositions among the connected resources. For example, as shown in FIG. 7B, the connections may indicate that a beam width of a beam associated with the resource 0 included in the second set of resources in included within a beam width of a beam associated with the resource 0 included in the first set of resources and within a beam width of a beam associated with the resource 1 included in the first set of resources. From this information, the UE 120 may be enabled to extrapolate and/or perform predictions for the beam associated with the resource 0 in the first set of resources based at least in part on measurements of the resource 0 and the resource 1 that are included in the first set of resources, as described in more detail elsewhere herein.

Returning to FIG. 7A, as shown by reference number 720, the UE 120 may determine beam characteristics of, or spatial associations between, resources included in the first set of resources and the second set of resources. For example, the UE 120 may use the connection(s) to identify two or more resources that are associated with a spatial superposition of respective beams of the two or more resources (e.g., as depicted and described in more detail in connection with FIG. 7B). As another example, the UE 120 may determine linear combinations among resources included in the first set of resources and the second set of resources. In other words, the UE 120 may use the connections to obtain spatial information and/or beam information associated with resources included in the first set of resources and the second set of resources. The UE 120 may use this information to perform one or more predictions associated with beam management, as described elsewhere herein. For example, the UE 120 may provide this information and/or an indication of the connections as an input to an AI/ML model used for predictive beam management.

As shown by reference number 725, the network node 110 may transmit, and the UE 120 may receive, one or more signals using resources included in the first set of resources. For example, the network node 110 may transmit, and the UE 120 may receive, one or more SSBs or CSI-RSs using resources included in the first set of resources. As shown by reference number 730, the UE 120 may perform measurements of the signals that are associated with the first set of resources. For example, the UE 120 may perform L1 RSRP measurements of the signals that are associated with the first set of resources.

As shown by reference number 735, the UE 120 may determine one or more predicted measurements of the second set of resources using the measurements (e.g., performed as described above in connection with reference number 730) and the connections (e.g., indicated to the UE 120 as described above in connection with reference number 715 and/or FIG. 7B). For example, the UE 120 may input the measurements performed by the UE 120 and indication(s) of the connections (or beam/spatial information determined by the UE 120 based at least in part on the connection) to an AI/ML model. The AIML model may output predicted measurement values associated with the second set of resources, as described in more detail elsewhere herein.

As shown by reference number 740, the UE 120 may transmit, and the network node 110 may receive, a CSI report indicating measurement values associated with the first set of resources and the second set of resources. A first one or more measurement values, from the measurement values, associated with the first set of resources may be measured by the UE 120 (e.g., as described above in connection with reference number 730). A second one or more measurement values, from the measurement values, associated with the second set of resources may be predicted by the UE 120 based at least in part on the first one or more measurement values and the one or more connections (e.g., as described above in connection with reference number 735). In this way, the UE 120 may be enabled to perform predictive beam management without requiring detailed beamforming or spatial information associated with the network node 110 (e.g., associated with beamforming performed by the network node 110). This may reduce a signaling overhead associated with enabling the UE 120 to perform the predictive beam management.

In some aspects, based at least in part on performing the predictive beam management, a resource, included in the second set of resources, may be used as a QCL source resource for a TCI state. For example, the QCL source resource may be a QCL Type-D QCL (e.g., as defined, or otherwise fixed, by a wireless communication standard, such as the 3GPP). For example, a QCL Type-D may be associated with a shared spatial receive parameter between the source and target reference signals.

In some aspects, the UE 120 may receive, and the network node 110 may transmit, an indication of a TCI state that is associated with a QCL source reference that is associated with at least one resource from the second set of resources. For example, based at least in part on performing the predictive beam management, the TCI state may be a known TCI state (e.g., based at least in part on a measurement value associated with the at least one resource being included in the second one or more measurement values included in the CSI report).

For example, a beam may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. A spatial relation may indicate a directionality or a characteristic of the uplink beam, similar to one or more QCL properties, as described above.

In some aspects, the UE 120 and/or the network node 110 may perform TCI state switching. TCI state switching may involve known TCI states and unknown TCI states. A TCI state switching timeline may specify the delay between receiving a reference signal (RS) resource (e.g., CSI-RS, SSB) used for L1 RSRP measurement reporting for the target TCI state (activated TCI state) and completion of an active TCI state switch. The RS resource is the RS in the activated TCI state or QCL′ed to the activated TCI state.

The TCI state switching timeline for the TCI state switching period may depend on whether an activated TCI state is known or unknown. A TCI state is known if multiple conditions are met. The multiple conditions may include: (condition #1) if the TCI state switch command is received within 1280 milliseconds (ms) upon the last transmission of the RS resource for beam reporting or measurement; (condition #2) if the UE has transmitted at least 1 L1 RSRP report for the target TCI state before the TCI state switch command; (condition #3) if the TCI state remains detectable during the TCI state switching period (e.g., from the slot carrying the TCI state activation MAC CE to TCI switching completion); and (condition #4) if the SSB associated with the TCI state remains detectable during the TCI switching period. An RS may be detectable by the UE if the signal-to-noise ratio (SNR) for the RS is greater than or equal to 3 dB. This does not necessarily mean that there must be such an RS being transmitted. This might be verified by the UE via other RSs (e.g., DMRS). If these conditions are not met, the TCI state is unknown. As described above, rather than relying on the multiple conditions, the UE 120 may consider a TCI state to be known if: (1) the UE 120 has been configured/activated/triggered with a CSI report, where the report quantitates of the CSI report are configured/indicated based at least in part on the second set of resources; and (2) the UE 120 having reported at least one predicted L1 RSRP value associated with the resource included in the second set of resources that is associated with the TCI state (e.g., as described above in connection with reference number 740). This may reduce an overhead associated with configuring TCI states and/or may enable the UE 120 to consider additional TCI states to be known by performing the predictive beam management.

As a result, the UE 120 may be enabled to perform improved predictive beam management by obtaining beam characteristics (e.g., beam shape and/or beam width) associated with the first set of resources and the second set of resources. Additionally, by using implicit connections between two sets of resources, the UE 120 and/or a network node 110 may conserve a signaling overhead, network resources, processing resources, and/or power associated with indicating the beam characteristics (e.g., beam shape and/or beam width) associated with the first set of resources and the second set of resources. For example, by using implicit connections between the two sets of resources, detailed beamforming information or implementations performed at a network node 110 do not need to be disclosed or indicated to the UE 120.

As indicated above, FIGS. 7A and 7B are provided as examples. Other examples may differ from what is described with respect to FIGS. 7A and 7B.

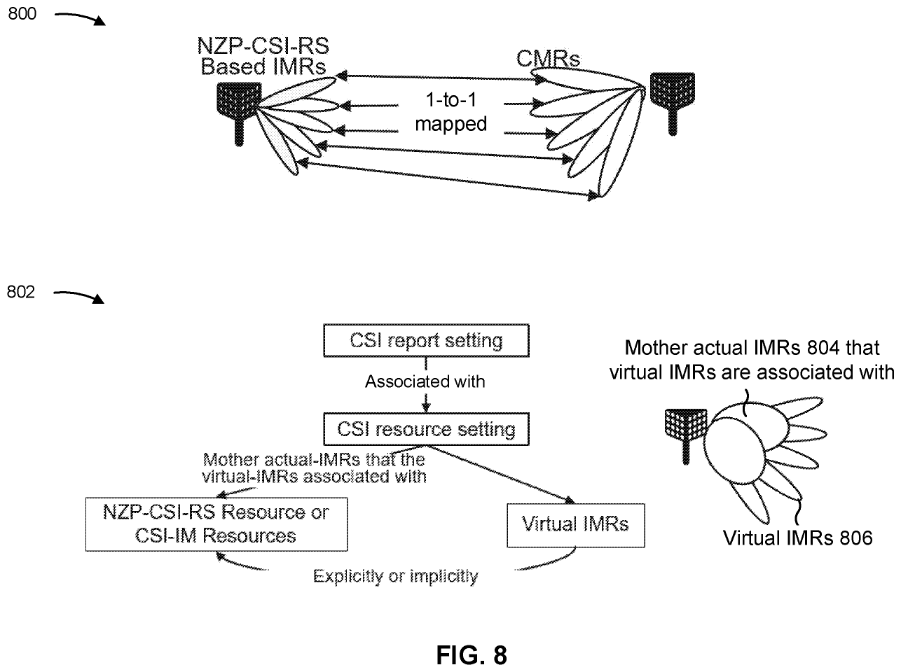

FIG. 8 is a diagram illustrating an example 800 of connections between CMRs and IMR, in accordance with the present disclosure.

CMRs may include SSBs or CSI-RS resources for channel measurements. A UE may apply an SSB or QCL Type-D RS to a non-zero power (NZP) CSI-RS resource for channel measurement, as the reference RS for determining a QCL Type D RS for the corresponding CMR. Interference measurements (e.g., L1 signal-to-interference-plus-noise ratio (SINR) measurements) may be based on instantaneously measured IMRs that include NZP-CSI-RS resources (e.g., CSI-RS beams that are transmitted by neighboring cell(s)) or CSI-IM resources (e.g., physical downlink shared channel (PDSCH) transmitted by neighboring cell(s)). Different beams may be transmitted to identify the IMRs. Except for L1-SINR, if an interference measurement is performed on an NZP-CSI-RS, the UE may not expect to be configured with more than one NZP-CSI-RS resource in the associated resource set within the resource setting for channel measurement.

CMRs may have connections to or may be associated with IMRs. The CMRs may be mapped one-to-one with the IMRs, for example, using CMR and IMR identifiers (IDs). That is, the quantity of CMRs may be equal to the quantity of IMRs. Example 800 shows IMRs that are one-to-one mapped to CMRs. If the UE is to provide a CSI report for CMRs, including all associated IMRs, there may be a significant amount of overhead (signaling resources). The transmission of the multiple IMRs and CMRs by the network may consume significant power and possibly introduce unwanted interference. The UE may consume significant processing resources performing beam switches, measurements, and analog to digital conversions for the multiple IMRs and CMRs. The UE may also have to consider different combinations of signal beams and interference beams in making beam predictions.

According to various aspects described herein, a UE may further reduce the consumption of power and signaling resources by using virtual IMRs that are used for beam management (e.g., beam prediction) but are not actually transmitted. The virtual IMRs may have beam shapes and/or beam directions in connection with actually transmitted IMRs. Actual IMRs 804 that are actually transmitted may be referred to as “mother IMRs,” as shown in example 802. The UE may use the actual IMRs 804 to predict the quality of virtual IMRs 806 based at least in part on the actual IMRs 804. The virtual IMRs 806 may have narrower beams than the actual IMRs 804 (mother IMRs). The UE may use the virtual IMRs 806 in combination with actual CMRs or virtual CMRs for beam prediction. The UE may also use actual IMRs 804 in combination with actual CMRs or virtual CMRs for beam prediction. The UE may transmit a CSI report based at least in part on less MMR transmissions and/or CMR transmissions. In this way, fewer transmissions are needed for channel and interference measurements for beam prediction. Power and signaling resources are conserved with fewer IMR transmissions. The UE may conserve processing resources by measuring and reporting for fewer actual IMRs.

The virtual IMRs 806, which are associated with the actual IMRs 804, may have measurements or other values that are used for beam prediction but are not transmitted. The network may later transmit the virtual IMRs 806 (to become actual IMRs). The network may transit CMRs such that the UE can identify the proper beam. As interference may come from a neighboring cell, the UE may not be able to identify a receive beam with an actual IMR. The UE may not measure an actual IMR but may rely on the neighboring cell to predict interference levels in certain directions of neighbor beams. The UE may not depend on actual IMRs, which may come from neighboring base stations or other UEs.

In some aspects, a UE may virtually predict different CMR and IMR hypotheses (combinations and values for combinations) instead of measuring all the CMRs and IMRs. Accordingly, the CSI report may indicate the reporting of a combination of virtual CMRs, actual CMRs, virtual IMR, and/or actual IMRs and indicate the associated L1-SINR/CQI/RI predictions. To reduce reporting overhead for such an interference hypothesis, references to the measured actual CMR and IMR interference could be referred to when determining which hypothesis is to be considered. The reference regarding the actual CMR and IMR combinations may be configured or indicated periodically, semi-periodically, or aperiodically for more flexibility.

Example 802 shows a CSI report setting that is associated with a CSI resource setting. In some aspects, for at least one CSI resource setting configuring IMRs associated with a CSI report setting for the CSI report, the IMRs configured by the CSI resource setting may be based at least in part on virtual IMR resources. The CSI resource setting configuring virtual IMRs 806 may additionally include actual IMRs based on conventional CSI-IMs or NZP-CSI-RSs (as mother IMRs), together with connections between the actual IMRs 804 and the virtual IMRs 806. For example, the CSI resource setting may indicate an explicit connection between the actual IMRs 804 and the virtual IMRs 806 based at least in part on beam pointing directions and/or beam width information associated with respective IMRs. Information about the explicit connection may be configured or indicated via absolute beam pointing directions or beam width information. Such information may be first configured or indicated via absolute beam pointing directions and/or beam widths of the actual IMRs 804, and further configured or indicated using differential beam pointing directions and/or beam widths of the virtual IMRs 806 referring to the beam pointing directions and/or beam widths associated with the actual IMRs 804.

The connection between the actual IMRs 804 and the virtual IMRs 806 may be implicitly configured or indicated via a one-to-one mapping or a one-to-many mapping. The UE may predict interference and noise caused by the virtual IMRs, based at least in part on the signals received from the actual IMRs.

Referring to example 802, in an example, a CSI resource setting may configure the actual IMRs 804 and the virtual IMRs 806. The actual IMRs 804 may be configured as N NZP-CSI-RS resources. A certain virtual IMR may be configured to be connected with the nth actual IMR (e.g., the nth NZP-CSI-RS resource). The connection may also indicate that the beam pointing direction of the virtual IMR is-15-degree shifted in azimuth versus the connected actual IMR, and a beam-width of the virtual IMR is half the beam-width of the actual IMR.

As indicated above, FIG. 8 is provided as an example. Other examples may differ from what is described with regard to FIG. 8.

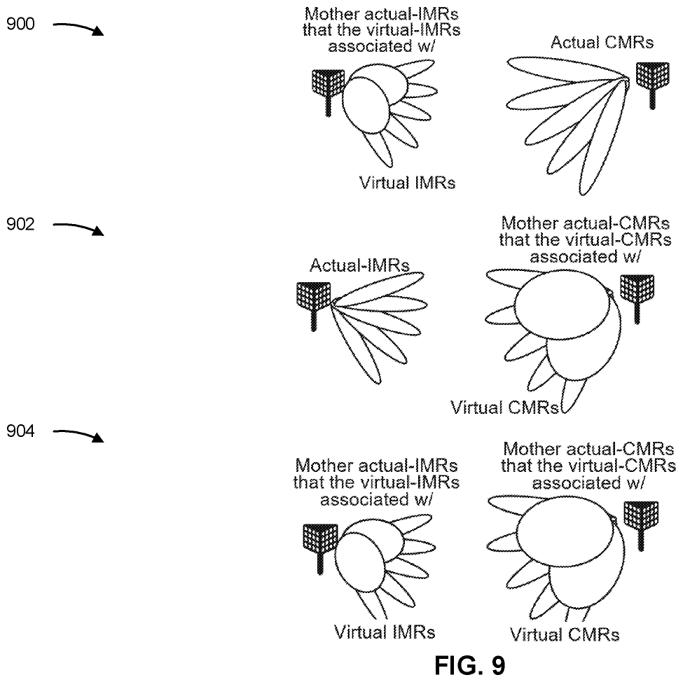

FIG. 9 is a diagram illustrating examples 900, 902, and 904 of CMR and IMR combinations, in accordance with the present disclosure.

A network entity may request a UE to provide feedback in a CSI report, where the CMR and IMR connections are used to report value or quantities, such as an RI, a CQI, a PMI, L1 measurements, an L1-SINR, and/or an L3-SINR, associated with the CSI report based at least in part on one of several scenarios. Example 900 shows a first scenario based at least in part on a combination of actual CMRs and virtual IMRs. Example 902 shows a second scenario based at least in part on a combination of virtual CMRs and actual IMRs. Example 904 shows a third scenario based at least in part on a combination of virtual CMRs and virtual IMRs.

In some aspects, resources for the virtual IMRs may include frequency and/or time frequency resources. For example, virtual IMRs may be defined with a virtual quantity of resource elements (REs) per physical resource block (PRB) and a total quantity of PRBs. Virtual resources may be defined as virtual QCL-Type D source resources.

In some aspects, actual (mother) IMRs may be based at least in part on CSI-IM resources or NZP-CSI-RS resources (considered to be wider beams). CSI-IMs, involving instantaneous downlink interference caused by neighboring cells with narrow transmission beams, may be considered to be spatially down-sampled directions due to instantaneous interference. The UE may predict virtual interference caused in directions based at least in part on such CSI-IMs. Actual IMRs may be from interference from a neighboring cell. If the interference comes from different directions, the UE may just measure interference from a limited spatial set to conserve resources and then predict interference for the rest of the directions.

As indicated above, FIG. 9 is provided as an example. Other examples may differ from what is described with regard to FIG. 9.

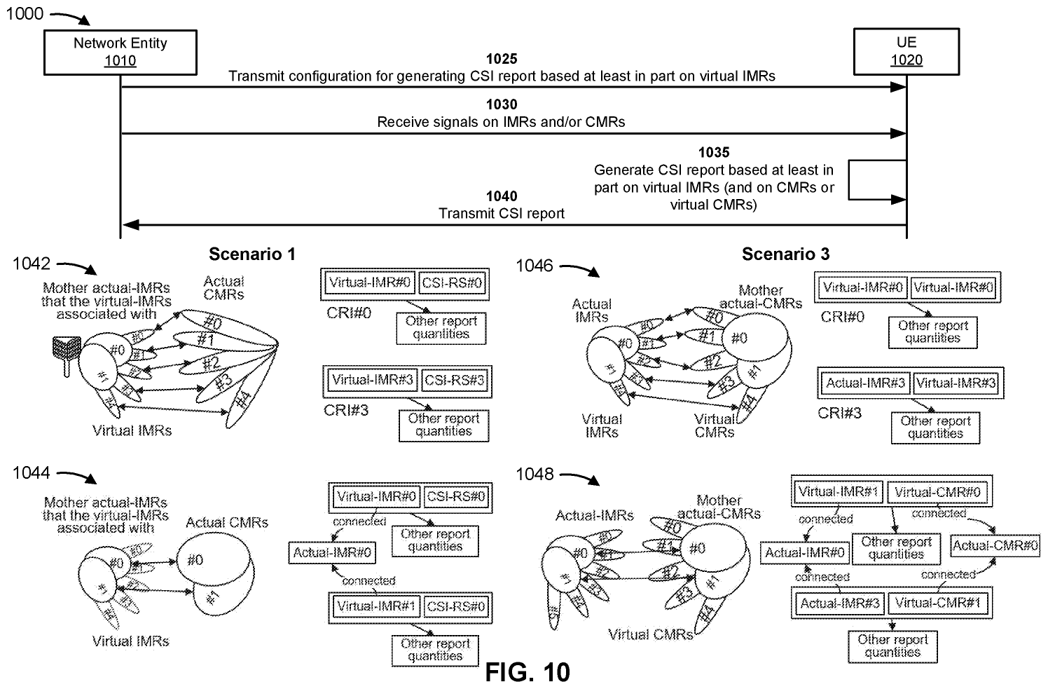

FIG. 10 is a diagram illustrating an example 1000 associated with generating a CSI report based on virtual IMRs, in accordance with the present disclosure. As shown in FIG. 10, a network entity 1010 (e.g., network node 110, a CU, a DU, and/or an RU) may communicate with a UE 1020 (e.g., UE 120). In some aspects, the network entity 1010 and the UE 1020 may be part of a wireless network (e.g., the wireless network 100). The UE 1020 and the network entity 1010 may have established a wireless connection prior to operations shown in FIG. 10.

In some aspects, the 1020 UE may generate a CSI report based at least in part on virtual IMRs. Each virtual IMR may represent a logical resource that is used for beam management and is not transmitted. In some aspects, each virtual IMR of the one or more virtual IMRs is a QCL source resource for a TCI state that corresponds to a QCL for a TCI state of a CMR of the CMRs that are transmitted.

Example 1000 shows the UE 1020 using virtual IMRs. The UE 1020 may generate the CSI report based at least in part on a combination of virtual IMRs and (actual) CMRs, as shown by the first scenario 900 in FIG. 9. Alternatively, the UE 1020 may generate a CSI report based at least in part on a combination of virtual IMRs and virtual CMRs, as shown by the third scenario 904 in FIG. 9. Each virtual CMR may represent a logical resource that is used for beam management and is not transmitted.

As shown by reference number 1025, the network entity 1010 may transmit a configuration for generating a CSI report based at least in part on virtual IMRs and CMRs or based at least in part on virtual IMRs and virtual CMRs. The UE 1020 may receive the configuration for generating the CSI report based at least in part on virtual IMRs and CMRs or based at least in part on virtual IMRs and virtual CMRs. The network entity 1010 may transmit, and the UE 1020 may receive, an indication of the virtual IMRs and/or the virtual CMRs. As shown by reference number 1030, the UE 1020 may receive IMRs and/or CMRs that are actually transmitted. For example, the UE 1020 may receive signals, transmitted by the network entity 1010, on the IMRs and/or CMRs that are actually transmitted. The virtual IMRs may be connected to these IMRs. The virtual CMRs may be connected to these CMRs.

As shown by reference number 1035, the UE 1020 may generate a CSI report based at least in part on the virtual IMRs. As shown by reference number 1040, the UE 1020 may transmit, and the network entity 1010 may receive, the CSI report. The CSI report may also be based on CMRs or virtual CMRs. For example, in association with Scenario 1 shown by examples 1042 and 1044, the virtual IMRs may be associated with the CMRs. The CSI report may be based at least in part on measurements of the CMRs. The CSI report may be based at least in part on association with the IMRs that are transmitted. A beam shape of each virtual IMR may be associated with a beam shape of a respective CMR. Example 1042 shows the CMRs as narrow beams associated with narrow beams for the IMRs, and example 1044 shows the CMRs as wider beams associated with the wider beams for IMRs. In some aspects, the CSI report may be further based at least in part on traffic conditions or a traffic payload.

In some aspects, the UE 1020 may determine a combination of CMRs and IMRs (among one or more possible combinations such as IMR #1-CMR #1, IMR #2-CMR #2, IMR #3-CMR #3, and so forth) that provide a signal strength and/or quality that satisfies (e.g., meets or exceeds) a threshold (e.g., minimum RSRP or minimum SINR). The UE 1020 may predict one or more measurements (e.g., RSRP, RI, CQI, PMI, L1-SINr, and/or L3-SINR) based at least in part on the combination. The UE 1020 may transmit a prediction indication of the predicted measurements.

The quantity of the CMRs may be equal to the quantity of the virtual IMRs, as shown by example 1042. When reporting a CSI-RS resource indicator (CRI) or an SSB resource indicator (SSBRI), the CRI/SSBRI k (k>0) may correspond to the (k+1)th actual CMR and the (k+1)th virtual IMR. Alternatively, the quantity of the CMRs may not be equal to the quantity of the virtual IMRs, as shown by example 1044. The UE 1020 may report a CRI/SSBRI associated with an actual CMR, further report an identifier associated with a virtual IMR, and finally report other quantities whose SINR is decided by the reported combination of CMR and IMR.

In an example associated with example 1044, the quantity of CMRs and the quantity of IMRs (as mother IMRs of the virtual IMRs) may be the same and each CMR and IMR may be associated or mapped one-to-one. The UE 1020 may first identify (and optionally also report together with L1-SINR/CQI) one or more combinations of CMR and IMR that can provide the best (e.g., greatest) L1-SINR, RI, or CQI. The UE 1020 may further predict one or multiple sets of report quantities for each of such combinations, where each set of quantities is determined based at least in part on the assumption that CMR is used as the CMR in the associated combination, while IMR is used as a virtual IMR connected with the mother actual IMR associated with the combination. The UE 1020 may report one or more sets of the predicted quantities for such identified combinations, (optionally) together with the associated CMR-ID and associated virtual IMR-ID.

In another example associated with Scenario 3 shown by examples 1046 and 1048, the virtual IMRs may be associated with virtual CMRs. The UE 1020 may determine a combination of virtual CMRs and IMRs (among one or more possible combinations) that provide a signal strength and/or quality that satisfies the threshold. The UE 1020 may predict one or more measurements based at least in part on the combination. The UE 1020 may transmit a prediction indication of the predicted measurements. In some aspects, each virtual IMR of the one or more virtual IMRs may be a QCL source resource for a TCI state that corresponds to a QCL for a TCI state of a virtual CMR of the one or more virtual CMRs.

The quantity of the virtual CMRs may be equal to the quantity of the virtual IMRs, as shown by example 1046. When reporting a joint resource identifier, identifier k (k>0) may correspond to the (k+1)th virtual CMR and the (k+1)th virtual IMR. Alternatively, the quantity of the virtual CMRs may not be equal to the quantity of the virtual IMRs, as shown by example 1048. The UE 1020 may report an identifier associated with a virtual CMR, further report an identifier associated with a virtual IMR, and finally report other quantities whose SINR is decided by the reported combination of CMR and IMR.

In an example, the quantity of CMRs (mother CMRs of virtual CMRs) and the quantity of IMRs (as mother IMRs of the virtual IMRs) may be the same and each CMR and IMR may be associated or mapped one-to-one. The UE 1020 may first identify (and optionally also report together with L1-SINR/CQI) one or more combinations of CMR and IMR that can provide the best (e.g., greatest) L1-SINR, RI, or CQI. The UE 1020 may further predict one or multiple sets of report quantities for each of such combinations, where each set of quantities is determined based at least in part on the assumption that IMR is used as a virtual IMR connected with the mother IMR associated with the combination, while CMR is used as a virtual CMR connected with the mother CMR associated with the combination. The UE 1020 may report one or more sets of the predicted quantities for such identified combinations, (optionally) together with the associated virtual CMR-ID and the associated virtual IMR-ID.

As indicated above, FIG. 10 is provided as an example. Other examples may differ from what is described with regard to FIG. 10.

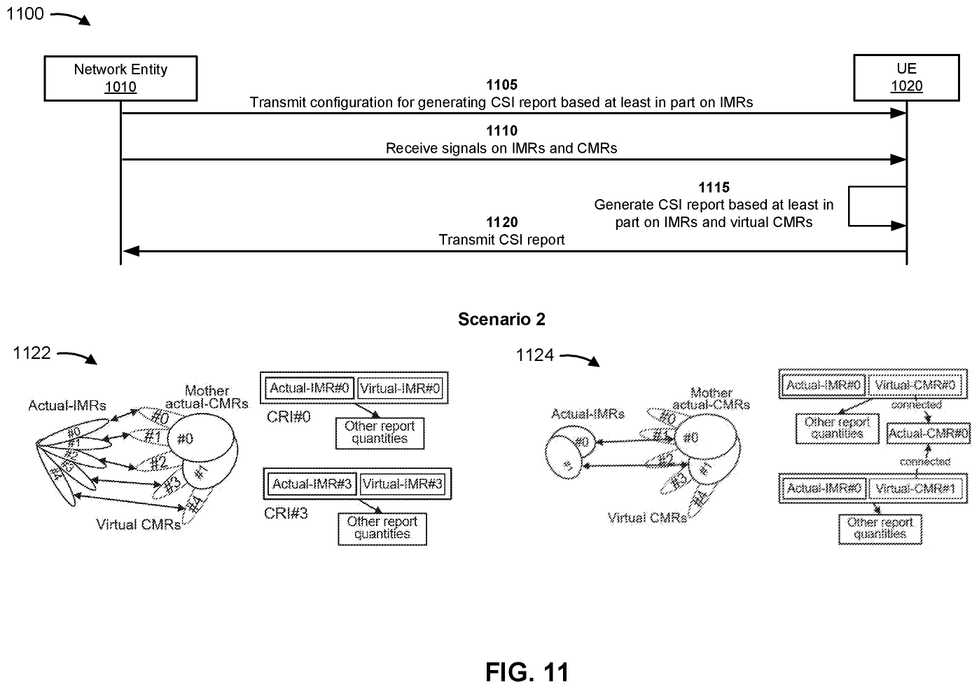

FIG. 11 is a diagram illustrating an example 1100 associated with generating a CSI report based on actual IMRs, in accordance with the present disclosure.

In some aspects, the 1020 UE may generate a CSI report based at least in part on actual IMRs as shown by the second scenario 902 in FIG. 9. Example 1100 shows the UE 1020 using IMRs. The UE 1020 may generate the CSI report based at least in part on a combination of MMRs and virtual CMRs.

As shown by reference number 1105, the network entity 1010 may transmit a configuration for generating a CSI report based at least in part on IMRs and virtual CMRs. The UE 1020 may receive the configuration for generating the CSI report based at least in part on IMRs and virtual CMRs. The network entity 1010 may transmit, and the UE 1020 may receive, an indication of the virtual CMRs. As shown by reference number 1110, the UE 1020 may receive IMRs and/or CMRs that are actually transmitted. For example, the UE 1020 may receive signals, transmitted by the network entity 1010, on the IMRs and/or CMRs that are actually transmitted. The virtual CMRs may be connected to these CMRs.

As shown by reference number 1115, the UE 1020 may generate a CSI report based at least in part on the IMRs and the virtual CMRs. As shown by reference number 1120, the UE 1020 may transmit, and the network entity 1010 may receive, the CSI report.

In some aspects, in association with Scenario 2 shown by examples 1122 and 1124, the UE 1020 may determine a combination of virtual CMRs and IMRs that provide a signal strength and/or quality that satisfies (e.g., meets or exceeds) a threshold (e.g., minimum RSRP, minimum SINR). The UE 1020 may predict one or more measurements (e.g., RSRP, RI, CQI, PMI, L1-SINr, L3-SINR) based at least in part on the combination. The UE 1020 may transmit a prediction indication of the predicted measurements.

The quantity of the virtual CMRs may be equal to the quantity of the IMRs, as shown by example 1122. When reporting a CRI or an SSBRI, the CRI/SSBRI k (k>0) may correspond to the (k+1)th actual CMR and the (k+1)th virtual IMR. Alternatively, the quantity of the virtual CMRs may not be equal to the quantity of the IMRs, as shown by example 1124. The UE 1020 may report an identifier associated with a virtual CMR, further report an identifier associated with an IMR, and finally report other quantities whose SINR is decided by the reported combination of virtual CMR and IMR.

In an example associated with example 1124, the quantity of CMRs (as mother CMRs of the virtual CMRs) and the quantity of IMRs may be the same and each CMR and IMR may be associated or mapped one-to-one. The UE 1020 may first identify (and optionally also report together with L1-SINR/CQI) one or more combinations of CMR and IMR that can provide the best (e.g., greatest) L1-SINR, RI, or CQI. The UE 1020 may further predict one or multiple sets of report quantities for each of such combinations, where each set of quantities is determined based at least in part on the assumption that the IMR is used in the associated combination, while CMR is used as a virtual CMR connected with the mother actual CMR associated with the combination. The UE 1020 may report one or more sets of the predicted quantities for such identified combinations, (optionally) together with the associated CMR-ID and associated virtual IMR-ID.

As indicated above, FIG. 11 is provided as an example. Other examples may differ from what is described with regard to FIG. 11.

In some aspects, the CSI report may indicate one or more resource sets or sets of interference hypotheses (values) associated with one or more combinations of CMR/virtual CMR and IMR/virtual IMR based at least in part on a CSI report configuration. In an example, a quantity of virtual CMRs/IMRs may be addressed in the CSI report. The quantity of hypothesis sets associated with a certain identified combination may be addressed in a CSI report and may be based at least in part on a reporting configuration or indication. For example, 4 sets may be addressed for the actual-IMR and actual-CMR combination providing the strongest L1-SINR, while 1 set may be addressed for the remaining combinations. The configuration or indication may be an RRC configuration for the CSI report setting associated with a CSI report, indicated by the MAC CE activating a semi-persistent CSI report, an RRC configuration by an aperiodic CSI triggering state configuration associated with an AP CSI report, or DCI indicated when the aperiodic CSI report is triggered by the DCI.

In some aspects, QCL Assumptions for Virtual IMRs may be used for determining other report quantities (e.g., measurements). A one-to-one mapped IMR's QCL Type-D may be expected to be the same as a paired CMR. When determining the report quantities of the CSI report, the QCL-Type D associated with a virtual IMR, considering a specific actual/virtual CMR and IMR combination, may be expected to be identical to the QCL Type D source of the paired CMR. For example, when a combination of an actual CMR and a virtual-IMR is considered, the QCL-Type D for the virtual-IMR may be the QCL-Type D of the actual CMR. That is, the UE 1020 may expect that a receive spatial filter for receiving the considered actual CMR is used when predicting interference or noise caused by the virtual IMR. In another example, when the combination of virtual CMR and virtual IMR is considered, the QCL-Type D for the virtual IMR may be the QCL-Type D of the virtual CMR. For example, the UE 1020 may receive an indication from the network entity 1010, such that the virtual CMR's QCL-Type D source is a mother actual CMR, and the UE 1020 may expect that a receive spatial filter for receiving the mother actual CMR is used when predicting interference or noise caused by the virtual IMR.

In some aspects, QCL assumptions for virtual IMRs may be used for predicting interference of virtual IMRs based at least in part on mother IMRs. Note that in order to better estimate interference caused by virtual IMRs based on mother IMRs, instead of measuring the mother IMRs based on spatial receive filters associated with corresponding CMRs, it may be better for the UE to use spatial receive filters to directly measure the mother IMRs. When predicting interference associated with virtual IMRs based on actual IMRs, the QCL-Type D associated with an actual IMR may be different from the actual/virtual CMR associated with the IMR. That is, the QCL-Type D associated with an actual IMR may be different from a QCL-Type D assumption.

In some aspects, the CSI report may indicate an uncertainty level of one or more values in the CSI report. The values may be associated with other report quantities (e.g., measurements). When virtual CMRs and virtual IMRs are involved with calculating a SINR when reporting report quantities (including at least RI/CQI/PMI/L1/L1-SINR/L3-SINR), the UE 1020 may additionally report uncertainty level(s) associated with such report quantities. For example, conventional CQI may be determined based on actual measurements or predictions. Therefore, it would be beneficial for the UE 1020 to report the uncertainty level associated with the report if predictions are involved. In another example, the uncertainty level may be represented by variance or a standard deviation associated with a predicted report quantity (e.g., mean-CQI and std-CQI).

By using virtual IMRs and/or virtual CMRs, a UE and the network may conserve power, processing resources, and signaling resources.

FIG. 12 is a diagram illustrating an example process 1200 performed, for example, by a UE, in accordance with the present disclosure. Example process 1200 is an example where the UE (e.g., UE 120, UE 1020) performs operations associated with CSI reporting using virtual IMRs.

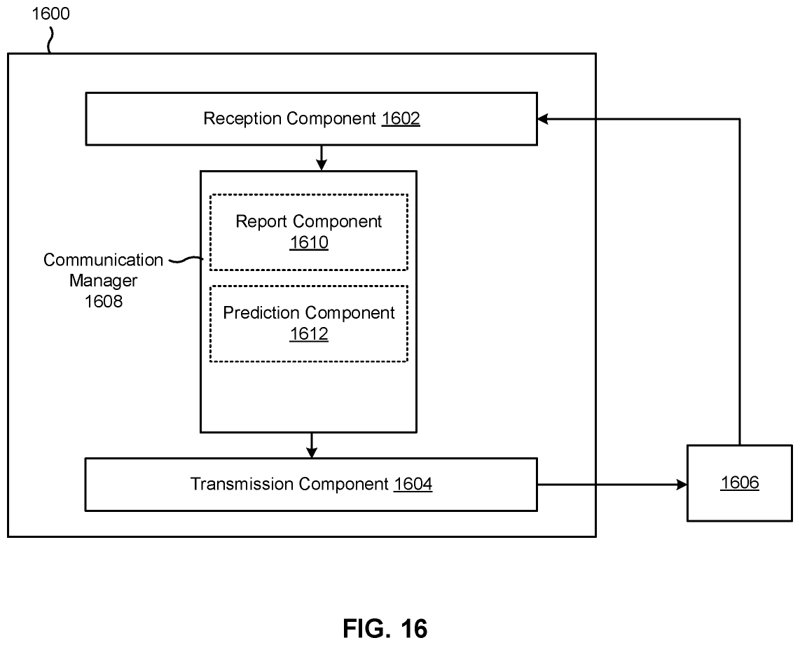

As shown in FIG. 12, in some aspects, process 1200 may include generating a CSI report based at least in part on one or more virtual IMRs, each virtual IMR representing a logical resource that is used for beam management and is not transmitted (block 1210). For example, the UE (e.g., using communication manager 1608 and/or report component 1610 depicted in FIG. 16) may generate a CSI report based at least in part on one or more virtual IMRs, each virtual IMR representing a logical resource that is used for beam management and is not transmitted, as described above.

As further shown in FIG. 12, in some aspects, process 1200 may include transmitting the CSI report (block 1220). For example, the UE (e.g., using communication manager 1608 and/or transmission component 1604 depicted in FIG. 16) may transmit the CSI report, as described above.

Process 1200 may include additional aspects, such as any single aspect or any combination of aspects described below and/or in connection with one or more other processes described elsewhere herein.

In a first aspect, process 1200 includes receiving a virtual IMR indication of the one or more virtual IMRs.

In a second aspect, alone or in combination with the first aspect, generating the CSI report includes generating the CSI report further based at least in part on a traffic payload.

In a third aspect, alone or in combination with one or more of the first and second aspects, the one or more virtual IMRs are associated with one or more CMRs that are transmitted, and generating the CSI report includes generating the CSI report further based at least in part on measurements of the one or more CMRs.

In a fourth aspect, alone or in combination with one or more of the first through third aspects, a beam shape of each virtual IMR is associated with a beam shape of a respective CMR.

In a fifth aspect, alone or in combination with one or more of the first through fourth aspects, generating the CSI report includes generating the CSI report further based at least in part on association with one or more IMRs that are transmitted.

In a sixth aspect, alone or in combination with one or more of the first through fifth aspects, process 1200 includes determining a combination of CMRs that are transmitted and IMRs that provide a signal strength or quality that satisfies a threshold.

In a seventh aspect, alone or in combination with one or more of the first through sixth aspects, process 1200 includes predicting one or more measurements based at least in part on the determined combination, and transmitting a prediction indication of the predicted one or more measurements.

In an eighth aspect, alone or in combination with one or more of the first through seventh aspects, process 1200 includes predicting interference of one or more virtual IMRs based at least in part on the one or more IMRs.

In a ninth aspect, alone or in combination with one or more of the first through eighth aspects, process 1200 includes determining a combination of CMRs that are transmitted and virtual IMRs that provide a signal strength or quality that satisfies a threshold.

In a tenth aspect, alone or in combination with one or more of the first through ninth aspects, process 1200 includes predicting one or more measurements based at least in part on the determined combination, and transmitting a prediction indication of the predicted one or more measurements.

In an eleventh aspect, alone or in combination with one or more of the first through tenth aspects, each virtual IMR of the one or more virtual IMRs is a QCL source resource for a TCI state that corresponds to a QCL for a TCI state of a CMR of one or more CMRs that are transmitted.

In a twelfth aspect, alone or in combination with one or more of the first through eleventh aspects, a quantity of the one or more CMRs is equal to a quantity of the one or more virtual IMRs.

In a thirteenth aspect, alone or in combination with one or more of the first through twelfth aspects, a quantity of the one or more CMRs is not equal to a quantity of the one or more virtual IMRs.

In a fourteenth aspect, alone or in combination with one or more of the first through thirteenth aspects, the one or more virtual IMRs are associated with one or more virtual CMRs, each virtual CMR representing a logical resource that is used for beam management and is not transmitted, and generating the CSI report includes generating the CSI report further based at least in part on the one or more virtual CMRs.

In a fifteenth aspect, alone or in combination with one or more of the first through fourteenth aspects, a quantity of the one or more virtual CMRs is equal to a quantity of the one or more virtual IMRs.

In a sixteenth aspect, alone or in combination with one or more of the first through fifteenth aspects, a quantity of the one or more virtual CMRs is not equal to a quantity of the one or more virtual IMRs.

In a seventeenth aspect, alone or in combination with one or more of the first through sixteenth aspects, process 1200 includes determining a combination of virtual CMRs and virtual IMRs that provides a signal strength or quality that satisfies a threshold.

In an eighteenth aspect, alone or in combination with one or more of the first through seventeenth aspects, process 1200 includes predicting one or more measurements based at least in part on the determined combination, and transmitting a prediction indication of the predicted one or more measurements.

In a nineteenth aspect, alone or in combination with one or more of the first through eighteenth aspects, the CSI report indicates one or more resource sets or sets of interference hypotheses associated with the determined combination based at least in part on a report configuration.

In a twentieth aspect, alone or in combination with one or more of the first through nineteenth aspects, each virtual IMR of the one or more virtual IMRs is a QCL source resource for a TCI state that corresponds to a QCL for a TCI state of a virtual CMR of the one or more virtual CMRs.

In a twenty-first aspect, alone or in combination with one or more of the first through twentieth aspects, the CSI report indicates an uncertainty level of one or more values in the CSI report.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120, UE 1020) performs operations associated with CSI reporting using actual IMRs and virtual CMRs.

As shown in FIG. 13, in some aspects, process 1300 may include generating a CSI report based at least in part on one or more IMRs that are transmitted and one or more virtual CMRs, each virtual CMR representing a logical resource that is used for beam management and is not transmitted (block 1310). For example, the UE (e.g., using communication manager 1608 and/or report component 1610 depicted in FIG. 16) may generate a CSI report based at least in part on one or more IMRs that are transmitted and one or more virtual CMRs, each virtual CMR representing a logical resource that is used for beam management and is not transmitted, as described above.

As further shown in FIG. 13, in some aspects, process 1300 may include transmitting the CSI report (block 1320). For example, the UE (e.g., using communication manager 1608 and/or transmission component 1604 depicted in FIG. 16) may transmit the CSI report, as described above.

Process 1300 may include additional aspects, such as any single aspect or any combination of aspects described below and/or in connection with one or more other processes described elsewhere herein.

In a first aspect, a quantity of the one or more virtual CMRs is equal to a quantity of the one or more IMRs.

In a second aspect, alone or in combination with the first aspect, a quantity of the one or more virtual CMRs is not equal to a quantity of the one or more IMRs.

In a third aspect, alone or in combination with one or more of the first and second aspects, process 1300 includes determining a combination of virtual CMRs and IMRs that provides a signal strength or quality that satisfies a threshold.

In a fourth aspect, alone or in combination with one or more of the first through third aspects, process 1300 includes predicting one or more measurements based at least in part on the determined combination, and transmitting a prediction indication of the predicted one or more measurements.

In a fifth aspect, alone or in combination with one or more of the first through fourth aspects, each IMR of the one or more IMRs is a QCL source resource for a TCI state that corresponds to a QCL for a TCI state of a virtual CMR of the one or more virtual CMRs.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., network node 110, network entity 1010) performs operations associated with CSI reporting using virtual IMRs.

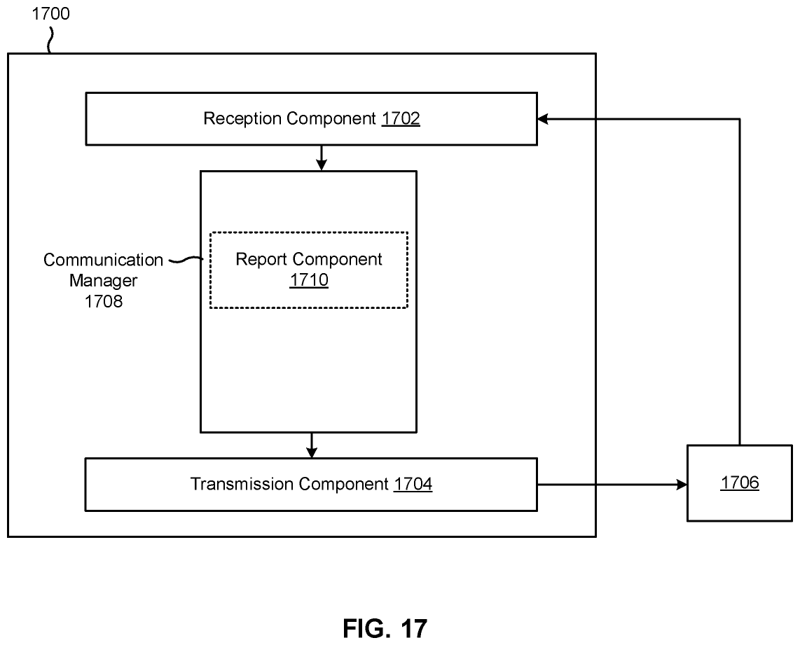

As shown in FIG. 14, in some aspects, process 1400 may include transmitting a configuration for generating a CSI report based at least in part on one or more virtual IMRs, each virtual IMR representing a logical resource that is used for beam management and is not transmitted, and one or more of: one or more CMRs, or one or more virtual CMRs, each virtual CMR representing a logical resource that is used for beam management and is not transmitted (block 1410). For example, the network entity (e.g., using communication manager 1708 and/or transmission component 1704 depicted in FIG. 17) may transmit a configuration for generating a CSI report based at least in part on one or more virtual IMRs, each virtual IMR representing a logical resource that is used for beam management and is not transmitted, and one or more of: one or more CMRs, or one or more virtual CMRs, each virtual CMR representing a logical resource that is used for beam management and is not transmitted, as described above.

As further shown in FIG. 14, in some aspects, process 1400 may include receiving the CSI report (block 1420). For example, the network entity (e.g., using communication manager 1708 and/or reception component 1702 depicted in FIG. 17) may receive the CSI report, as described above.

Process 1400 may include additional aspects, such as any single aspect or any combination of aspects described below and/or in connection with one or more other processes described elsewhere herein.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network entity, in accordance with the present disclosure. Example process 1500 is an example where the network entity (e.g., network node 110, network entity 1010) performs operations associated with CSI reporting using actual IMRs and virtual CMRs.

As shown in FIG. 15, in some aspects, process 1500 may include transmitting a configuration for generating a CSI report based at least in part on one or more IMRs that are transmitted and one or more virtual CMRs, each virtual CMR representing a logical resource that is used for beam management and is not transmitted (block 1510). For example, the network entity (e.g., using communication manager 1708 and/or transmission component 1704 depicted in FIG. 17) may transmit a configuration for generating a CSI report based at least in part on one or more IMRs that are transmitted and one or more virtual CMRs, each virtual CMR representing a logical resource that is used for beam management and is not transmitted, as described above.

As further shown in FIG. 15, in some aspects, process 1500 may include receiving the CSI report (block 1520). For example, the network entity (e.g., using communication manager 1708 and/or reception component 1702 depicted in FIG. 17) may receive the CSI report, as described above.

Process 1500 may include additional aspects, such as any single aspect or any combination of aspects described below and/or in connection with one or more other processes described elsewhere herein.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE (e.g., UE 120, UE 1020), or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the UE described in connection with FIG. 2. The communication manager 1608 may be, or be similar to, the communication manager 140 depicted in FIGS. 1 and 2. For example, in some aspects, the communication manager 1608 may be configured to perform one or more of the functions described as being performed by the communication manager 140. In some aspects, the communication manager 1608 may include the reception component 1602 and/or the transmission component 1604. The communication manager 140 may include one or more of a report component 1610 and/or a prediction component 1612, among other examples.

In some aspects, the apparatus 1600 may be configured to perform one or more operations described herein in connection with FIGS. 1-11. Additionally, or alternatively, the apparatus 1600 may be configured to perform one or more processes described herein, such as process 1200 of FIG. 12, process 1300 of FIG. 13, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory.

For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

In some aspects, the report component 1610 may generate a CSI report based at least in part on one or more virtual IMRs, each virtual IMR representing a logical resource that is used for beam management and is not transmitted. The transmission component 1604 may transmit the CSI report.

The reception component 1602 may receive a virtual IMR indication of the one or more virtual IMRs. The prediction component 1612 may determine a combination of CMRs that are transmitted and IMRs that provide a signal strength or quality that satisfies a threshold. The prediction component 1612 may predict one or more measurements based at least in part on the determined combination. The transmission component 1604 may transmit a prediction indication of the predicted one or more measurements.

The prediction component 1612 may predict interference of one or more virtual IMRs based at least in part on the one or more IMRs. The prediction component 1612 may determine a combination of CMRs that are transmitted and virtual IMRs that provide a signal strength or quality that satisfies a threshold.

The prediction component 1612 may predict one or more measurements based at least in part on the determined combination. The transmission component 1604 may transmit a prediction indication of the predicted one or more measurements.

The prediction component 1612 may determine a combination of virtual CMRs and virtual IMRs that provides a signal strength or quality that satisfies a threshold. The prediction component 1612 may predict one or more measurements based at least in part on the determined combination. The transmission component 1604 may transmit a prediction indication of the predicted one or more measurements.

In some aspects, the report component 1610 may generate a CSI report based at least in part on one or more IMRs that are transmitted and one or more virtual CMRs, each virtual CMR representing a logical resource that is used for beam management and is not transmitted. The transmission component 1604 may transmit the CSI report.

The prediction component 1612 may determine a combination of virtual CMRs and IMRs that provides a signal strength or quality that satisfies a threshold. The prediction component 1612 may predict one or more measurements based at least in part on the determined combination. The transmission component 1604 may transmit a prediction indication of the predicted one or more measurements.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network entity (e.g., network node 110, network entity 1010), or a network entity may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 1708. The communication manager 1708 may control and/or otherwise manage one or more operations of the reception component 1702 and/or the transmission component 1704. In some aspects, the communication manager 1708 may include one or more antennas, a modem, a controller/processor, a memory, or a combination thereof, of the network entity described in connection with FIG. 2. The communication manager 1708 may be, or be similar to, the communication manager 150 depicted in FIGS. 1 and 2. For example, in some aspects, the communication manager 1708 may be configured to perform one or more of the functions described as being performed by the communication manager 150. In some aspects, the communication manager 1708 may include the reception component 1702 and/or the transmission component 1704. The communication manager 1708 may include a report component 1710, among other examples.

In some aspects, the apparatus 1700 may be configured to perform one or more operations described herein in connection with FIGS. 1-11. Additionally, or alternatively, the apparatus 1700 may be configured to perform one or more processes described herein, such as process 1400 of FIG. 14, process 1500 of FIG. 15, or a combination thereof. In some aspects, the apparatus 1700 and/or one or more components shown in FIG. 17 may include one or more components of the network entity described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network entity described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network entity described in connection with FIG. 2. In some aspects, the transmission component 1704 may be co-located with the reception component 1702 in a transceiver.

In some aspects, the transmission component 1704 may transmit a configuration for generating a CSI report based at least in part on one or more virtual IMRs, each virtual IMR representing a logical resource that is used for beam management and is not transmitted, and one or more of: one or more CMRs, or one or more virtual CMRs, each virtual CMR representing a logical resource that is used for beam management and is not transmitted. The report component 1710 may generate the report. The reception component 1702 may receive the CSI report.

In some aspects, the transmission component 1704 may transmit a configuration for generating a CSI report based at least in part on one or more IMRs that are transmitted and one or more virtual CMRs, each virtual CMR representing a logical resource that is used for beam management and is not transmitted. The report component 1710 may generate the report. The reception component 1702 may receive the CSI report.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by an apparatus of a user equipment (UE), comprising: generating a channel state information (CSI) report based at least in part on one or more virtual interference measurement resources (IMRs), each virtual IMR representing a logical resource that is used for beam management and is not transmitted; and transmitting the CSI report.

Aspect 2: The method of Aspect 1, further comprising receiving a virtual IMR indication of the one or more virtual IMRs.

Aspect 3: The method of Aspect 1 or 2, wherein generating the CSI report includes generating the CSI report further based at least in part on a traffic payload.

Aspect 4: The method of any of Aspects 1-3, wherein the one or more virtual IMRs are associated with one or more channel measurement resources (CMRs) that are transmitted, and wherein generating the CSI report includes generating the CSI report further based at least in part on measurements of the one or more CMRs.

Aspect 5: The method of Aspect 4, wherein a beam shape of each virtual IMR is associated with a beam shape of a respective CMR.

Aspect 6: The method of Aspect 4 or 5, wherein generating the CSI report includes generating the CSI report further based at least in part on association with one or more IMRs that are transmitted.

Aspect 7: The method of Aspect 6, further comprising determining a combination of CMRs that are transmitted and IMRs that provide a signal strength or quality that satisfies a threshold.

Aspect 8: The method of Aspect 7, further comprising: predicting one or more measurements based at least in part on the determined combination; and transmitting a prediction indication of the predicted one or more measurements.

Aspect 9: The method of Aspect 6, further comprising predicting interference of one or more virtual IMRs based at least in part on the one or more IMRs.

Aspect 10: The method of any of Aspects 1-3, further comprising determining a combination of channel measurement resources (CMRs) that are transmitted and virtual IMRs that provide a signal strength or quality that satisfies a threshold.

Aspect 11: The method of Aspect 10, further comprising: predicting one or more measurements based at least in part on the determined combination; and transmitting a prediction indication of the predicted one or more measurements.

Aspect 12: The method of any of Aspects 1-11, wherein each virtual IMR of the one or more virtual IMRs is a quasi-co-location (QCL) source resource for a transmission configuration indicator (TCI) state that corresponds to a QCL for a TCI state of a channel measurement resource (CMR) of one or more CMRs that are transmitted.

Aspect 13: The method of Aspect 12, wherein a quantity of the one or more CMRs is equal to a quantity of the one or more virtual IMRs.

Aspect 14: The method of Aspect 12, wherein a quantity of the one or more CMRs is not equal to a quantity of the one or more virtual IMRs.

Aspect 15: The method of any of Aspects 1-3, wherein the one or more virtual IMRs are associated with one or more virtual channel measurement resources (CMRs), each virtual CMR representing a logical resource that is used for beam management and is not transmitted, and wherein generating the CSI report includes generating the CSI report further based at least in part on the one or more virtual CMRs.

Aspect 16: The method of Aspect 15, wherein a quantity of the one or more virtual CMRs is equal to a quantity of the one or more virtual IMRs.

Aspect 17: The method of Aspect 15, wherein a quantity of the one or more virtual CMRs is not equal to a quantity of the one or more virtual IMRs.

Aspect 18: The method of Aspect 17, further comprising determining a combination of virtual CMRs and virtual IMRs that provides a signal strength or quality that satisfies a threshold.

Aspect 19: The method of Aspect 18, further comprising: predicting one or more measurements based at least in part on the determined combination; and transmitting a prediction indication of the predicted one or more measurements.

Aspect 20: The method of Aspect 18 or 19, wherein the CSI report indicates one or more resource sets or sets of interference hypotheses associated with the determined combination based at least in part on a report configuration.

Aspect 21: The method of Aspect 15, wherein each virtual IMR of the one or more virtual IMRs is a quasi-co-location (QCL) source resource for a transmission configuration indicator (TCI) state that corresponds to a QCL for a TCI state of a virtual CMR of the one or more virtual CMRs.

Aspect 22: The method of any of Aspects 1-21, wherein the CSI report indicates an uncertainty level of one or more values in the CSI report.

Aspect 23: A method of wireless communication performed by an apparatus of a user equipment (UE), comprising: generating a channel state information (CSI) report based at least in part on one or more interference measurement resources (IMRs) that are transmitted and one or more virtual channel measurement resources (CMRs), each virtual CMR representing a logical resource that is used for beam management and is not transmitted; and transmitting the CSI report.

Aspect 24: The method of Aspect 23, wherein a quantity of the one or more virtual CMRs is equal to a quantity of the one or more IMRs.

Aspect 25: The method of Aspect 23, wherein a quantity of the one or more virtual CMRs is not equal to a quantity of the one or more IMRs.

Aspect 26: The method of any of Aspects 23-25, further comprising determining a combination of virtual CMRs and IMRs that provides a signal strength or quality that satisfies a threshold.

Aspect 27: The method of Aspect 26, further comprising: predicting one or more measurements based at least in part on the determined combination; and transmitting a prediction indication of the predicted one or more measurements.

Aspect 28: The method of any of Aspects 23-27, wherein each IMR of the one or more IMRs is a quasi-co-location (QCL) source resource for a transmission configuration indicator (TCI) state that corresponds to a QCL for a TCI state of a virtual CMR of the one or more virtual CMRs.

Aspect 29: A method of wireless communication performed by an apparatus of a network entity, comprising: transmitting a configuration for generating a channel state information (CSI) report based at least in part on one or more virtual IMRs, each virtual IMR representing a logical resource that is used for beam management and is not transmitted, and one or more of: one or more channel measurement resources (CMRs), or one or more virtual CMRs, each virtual CMR representing a logical resource that is used for beam management and is not transmitted; and receiving the CSI report.

Aspect 30: A method of wireless communication performed by an apparatus of a network entity, comprising: transmitting a configuration for generating a channel state information (CSI) report based at least in part on one or more interference measurement resources (IMRs) that are transmitted and one or more virtual channel measurement resources (CMRs), each virtual CMR representing a logical resource that is used for beam management and is not transmitted; and receiving the CSI report.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus of a user equipment (UE) for wireless communication, comprising:
a memory; and
one or more processors, coupled to the memory, configured to:
generate a channel state information (CSI) report based at least in part on one or more virtual interference measurement resources (IMRs), each virtual IMR representing a logical resource that is used for beam management and is not transmitted; and
transmit the CSI report.

2. The apparatus of claim 1, wherein the one or more processors are configured to receive a virtual IMR indication of the one or more virtual IMRs.

3. The apparatus of claim 1, wherein the one or more processors, to generate the CSI report, are configured to generate the CSI report further based at least in part on a traffic payload.

4. The apparatus of claim 1, wherein the one or more virtual IMRs are associated with one or more channel measurement resources (CMRs) that are transmitted, and wherein the one or more processors, to generate the CSI report, are configured to generate the CSI report further based at least in part on measurements of the one or more CMRs.

5. The apparatus of claim 4, wherein a beam shape of each virtual IMR is associated with a beam shape of a respective CMR.

6. The apparatus of claim 4, wherein the one or more processors, to generate the CSI report, are configured to generate the CSI report further based at least in part on association with one or more IMRs that are transmitted.

7. The apparatus of claim 6, wherein the one or more processors are configured to determine a combination of CMRs that are transmitted and IMRs that provide a signal strength or quality that satisfies a threshold.

8. The apparatus of claim 7, wherein the one or more processors are configured to:
predict one or more measurements based at least in part on the determined combination; and
transmit a prediction indication of the predicted one or more measurements.

9. The apparatus of claim 6, wherein the one or more processors are configured to predict interference of one or more virtual IMRs based at least in part on the one or more IMRs.

10. The apparatus of claim 1, wherein the one or more processors are configured to determine a combination of channel measurement resources (CMRs) that are transmitted and virtual IMRs that provide a signal strength or quality that satisfies a threshold.

11. The apparatus of claim 10, wherein the one or more processors are configured to:
predict one or more measurements based at least in part on the determined combination; and
transmit a prediction indication of the predicted one or more measurements.

12. The apparatus of claim 1, wherein each virtual IMR of the one or more virtual IMRs is a quasi-co-location (QCL) source resource for a transmission configuration indicator (TCI) state that corresponds to a QCL for a TCI state of a channel measurement resource (CMR) of one or more CMRs that are transmitted.

13. The apparatus of claim 12, wherein a quantity of the one or more CMRs is equal to a quantity of the one or more virtual IMRs.

14. The apparatus of claim 12, wherein a quantity of the one or more CMRs is not equal to a quantity of the one or more virtual IMRs.

15. The apparatus of claim 1, wherein the one or more virtual IMRs are associated with one or more virtual channel measurement resources (CMRs), each virtual CMR representing a logical resource that is used for beam management and is not transmitted, and wherein the one or more processors, to generate the CSI report, are configured to generate the CSI report further based at least in part on the one or more virtual CMRs.

16. The apparatus of claim 15, wherein a quantity of the one or more virtual CMRs is equal to a quantity of the one or more virtual IMRs.

17. The apparatus of claim 15, wherein a quantity of the one or more virtual CMRs is not equal to a quantity of the one or more virtual IMRs.

18. The apparatus of claim 17, wherein the one or more processors are configured to determine a combination of virtual CMRs and virtual IMRs that provides a signal strength or quality that satisfies a threshold.

19. (canceled)

20. (canceled)

21. (canceled)

22. The apparatus of claim 1, wherein the CSI report indicates an uncertainty level of one or more values in the CSI report.

23. (canceled)

24. (canceled)

25. (canceled)

26. (canceled)

27. (canceled)

28. (canceled)

29. An apparatus of a network entity for wireless communication, comprising:
a memory; and
one or more processors, coupled to the memory, configured to:
transmit a configuration for generating a channel state information (CSI) report based at least in part on one or more virtual IMRs, each virtual IMR representing a logical resource that is used for beam management and is not transmitted, and one or more of:
one or more channel measurement resources (CMRs), or
one or more virtual CMRs, each virtual CMR representing a logical resource that is used for beam management and is not transmitted; and
receive the CSI report.

30. (canceled)
